(19) United States
(12) Patent Application Publication
(10) Pub. No.: US 2014/0098247 A1
(43) Pub. Date: Apr. 10, 2014

(54) Home Automation And Smart Home Control Using Mobile Devices And Wireless Enabled Electrical Switches

(71) Applicants: Rekha K. Rao, (US); IP Holdings, Inc., Palo Alto, CA (US)

(72) Inventors: Sunil K. Rao, Palo Alto, CA (US); Raman K. Rao, Palo Alto, CA (US)

(73) Assignee: IP HOLDINGS, INC., Palo Alto, CA (US)

(21) Appl. No.: 14/100,975

(22) Filed: Dec. 9, 2013

Related U.S. Application Data
(63) Continuation of application No. 13/771,092, filed on Feb. 20, 2013, now abandoned.
Application No. 13/771,092 is a continuation-in-part of application No. 10/878,666, filed on Jun. 28, 2004.
Application No. 10/878,666 is a continuation of application No. 09/597,607, filed on Jun. 20, 2000, now Pat. No. 6,882,859.
Application No. 09/597,607 is a continuation-in-part of application No. 09/281,739, filed on Jun. 4, 1999, now Pat. No. 6,169,789.

(51) Int. Cl. H04W 4/20; G06F 3/00

(52) U.S. Cl. CPC H04W 4/20; G06F 3/005
USPC 348/207.1; 455/420

(57) ABSTRACT

A system and method for home control and automation including a smart home with control of devices and appliance using mobile devices, cellular telephones, smart devices and smart phones is described. The mobile device may download a software application configured to control an electrical switch or electrical power outlet. The mobile device may change the on or off state of the outlet or the power settings of the outlet. The mobile device may control other intelligent appliances including a television using a wireless connection. The electrical outlets may be enabled with a smart electrical switch that includes a wireless transmit and receive component such as WiFi. The electrical switch may be programmable and be identified with a unique identifier. The electrical outlets may include a sensor to detect smoke, temperature, light, pressure, or other factors. The mobile device and electrical switch may join the same wireless local area network.

### CROSS REFERENCE TO RELATED PATENT APPLICATIONS

The present application claims priority and is a continuation of U.S. application Ser. No. 13/771,092 filed Feb. 20, 2013, which is a continuation-in-part of U.S. application Ser. No. 10/878,666 filed Jun. 28, 2004, which claims priority and is a continuation of U.S. application Ser. No. 09/597,607 filed Jun. 20, 2000 (now U.S. Pat. No. 6,882,859 issued Apr. 19, 2005), which claims priority and is a continuation-in-part of U.S. application Ser. No. 09/281,739 filed Jun. 4, 1999 (now U.S. Pat. No. 6,169,789 issued Jan. 2, 2001); the contents of all the above referenced applications are incorporated herein by reference in their entirety and the present application claims priority to all the above referenced applications and issued patents.

### BACKGROUND

This disclosure relates generally to Portable Electronic Devices referred to as a Mobile Devices/Mobile Phones and the use of a Mobile Device/Mobile Phone to access and control other devices in a smart homes, smart office, connected environment, or on the Internet. The home environment contains an increasing number of connected Internet Protocol (IP) enabled wired and wireless devices. There is a need to control appliances in the home using a mobile device/mobile phone or a network server or cloud monitoring service. The Mobile Device (MD)/Mobile Phone (MP) referred to in this disclosure may be a Cellular Telephone (CT), Wireless Phone, Smart Phone, Tablet Computer, handheld computer, touch screen enabled user computing device, multifunction wireless device with software applications, Voice over IP Wireless Device or Wireless Video Phone. Various embodiments of the Mobile Device/Mobile Phone may be created. The Mobile Device/Mobile Phone can execute complex tasks previously resident on the personal computer, workstation, server, or a mainframe computer; more particularly, the Mobile Device/Mobile Phone leverages the tremendous power of both the Intranet and the Internet, local and network servers, and public, private, and virtual cloud servers. Intelligent telephony, appliances, devices, and equipment will find increasing use in modern society. There is a need for one single universal, handheld, lightweight, transportable, intelligent device that can compute, command, and control all these intelligent devices.

The Mobile Device/Mobile Phone is lightweight and portable. The Mobile Device/Wireless Phone comprises a built-in display, a microphone, speaker, keyboard, high speed transmit/receive device, such as a wireless local area network (WLAN) or 802.11a, b, c, x or WiFi radio, Bluetooth, Ethernet, USB 1.0, USB 2.0, USB 3.0, Zigbee, Global Positioning System (GPS), and may connect to an external display, or use a browser to connect to an Internet website. The Mobile Device/Mobile Phone may have a digital video or still camera including a front facing camera, a rear facing camera, a plurality of flashes including LED flashes, an image sensor, a motion sensor, and a light sensor. The Mobile Device/Mobile Phone may have additional input/output ports for connectivity to other devices. The Mobile Device/Mobile Phone has a transmitter, receiver, a digital signal processor(s), other processors, controller, display electronics and audio/video electronics. These functional blocks may be implemented using standard electronic, mechanical, or electromechanical components or custom electronic, mechanical, or electromechanical components by those knowledgeable in the art.

The Mobile Device/Mobile Phone is able to leverage the computing power of the network or local server to process data. The Mobile Device/Mobile Phone may serve as a transmit and receive hub and as a wireless connection sharing device or hotspot for a plurality of devices to connect to the Mobile Device/Mobile Phone and access other network or Internet websites or servers. Thus, the Mobile Device/Mobile Phone is able to access a network or local server and another peripheral Mobile Device/Mobile Phone.

The Mobile Device/Mobile Phone is able to transmit data inputted by the user to the network or local server or other devices for further processing. A user may input data into the Mobile Device/Mobile Phone by typing on the keyboard, inputting voice or sound through the Mobile Device/Mobile Phones speaker, touching the screen of the display on the Mobile Device/Mobile Phone, using a mouse that interfaces with the Mobile Device/Mobile Phone, using a pen that interfaces with the Mobile Device/Mobile Phone, using a finger that actuates a part of the screen, pressing multiple fingers in a multi-touch device, using a gesture that interfaces with the Mobile Device/Mobile Phone or through another method or device that interfaces with the Mobile Device/Mobile Phone. This data and commands generated by the Mobile Device/Mobile Phone may be sent to the local network server or other devices for further processing. The Mobile Device/Mobile Phone is able to retrieve data processed by the local or network server or other devices. The Mobile Device/Mobile Phone can then perform further processing or output this data through the display, the speaker, or another device that interfaces with the Mobile Device/Mobile Phone.

Multiple intelligent equipment, intelligent appliances, televisions, printers and other devices can be accessed by a single Mobile Device/Mobile Phone or multiple Mobile Device/Mobile Phones either through a local/network server or directly. Unique addressing identification of each intelligent device, sequencing of instructions, execution of commands will be performed via a common set of protocols and procedures that reside on a local or network server or on other intelligent devices.

Multiple Mobile Device/Mobile Phones may coexist in an environment to access a common set of intelligent equipment, intelligent appliances, televisions, printers, and other devices. Multiple Mobile Device/Mobile Phones will operate in this common environment without conflict by leveraging a common set of protocols that reside on the local or network server and the Mobile Device/Mobile Phone.

The Mobile Device/Mobile Phone with a built-in transmit/receive component, may access voice and data networks using local wireless networks including WiFi or 802.11a, b, c, x networks and public or cellular networks such as GSM, 2G, edge, 3G, TDMA, CDMA 2000, EV-DO Rev, 4G, HSPA+, mobile WiMax, 3GPP, Long Term Evolution (LTE), LTE Advanced, spread spectrum based networks, circuit switched networks, IP based networks, broadband systems, cable networks, DSL networks, hybrid, OFDMA multi-carrier transmission, or other wired or wireless communication lines to communicate with other intelligent devices that may be either resident locally or located across an Intranet or the Internet. Various cellular frequencies and bands may be used such as band 700, 800, 850. Various frequencies may be used such as those around 700-800 MHz, 1700 to 2200 MHz, or 2500 MHz. Various home appliances may be accessed in different frequencies. These frequencies are not intended to be limiting and may be programmatically updated using configurations software. The Mobile Device/Mobile Phone may be multi-band such as dual-band, tri-band, quad-band, or n-band, and an international wireless device. This two way or multi-way communication may be either wired or wireless. The Mobile Device/Mobile Phone may connect with a communication line or another intelligent appliance using a network directly/peer to peer or using a server. The Mobile Device/Mobile Phone may also work in tandem with multiple embedded radios, separated wireless 802.11 or cellular access points and transmit/receive devices that may exist in other appliances or work with a central host modem or transmit/receive unit.

The Mobile Device/Mobile Phone combines transmitting and receiving information, performing standard computing functions through use of a network or local server, interacting and commanding many intelligent peripheral devices around the home or office through wired or wireless means, telephony, handwriting recognition, barcode creating, reading and printing; magnetic stripe creating, reading and printing; electronic mail, which may include audio, text/graphics, and video; mass storage device and display features, video input/output, imaging, audio input/output, voice mail capability, voice synthesis, language translation with text to voice and voice to text capability built into one multi-function device.

The Mobile Device/Mobile Phone may convert voice to text, text to voice, or voice to voice in the same language or in another language. With the large computing/processing power of the local or network server the possibility to conduct live conversation in same or two or more different languages is feasible. Also text transcription of voice conversations and voice dictation and the reverse is possible. The Mobile Device/Mobile Phone may also include the option to have the keys in its keyboard be inscribed in Braille if a physical keyboard is present, vibrate or make sounds including spoken audio for individuals such as those that are visually impaired. The Mobile Device/Mobile Phone may have a built-in physical keyboard or a virtual keyboard. The Mobile Device/Mobile Phone may be limited to some or all of the features described above or may include all the features described above based on the options desired by the user.

In this age of the Intranet and the Internet, there is a trend for the computing power and software protocols to move away from the user location, such as the personal computer, to the local server/network server/cloud. The Mobile Device/Mobile Phone may use the local server/network server to perform complex operations, such as language translation. In addition, the Mobile Device/Mobile Phone may have some language translation capability resident in itself via language translation applications that may be easily downloaded and installed on the Mobile Device/Mobile Phone. The Mobile Device/Mobile Phone may access an application store or exchange to download applications configured to run on the Mobile Device/Mobile Phone. The Mobile Device/Mobile Phone may use a network cloud server for storage of content and automatic sharing of the content across multiple devices.

The Mobile Device/Mobile Phone integrates currently available functions such as transmitting keystrokes to a computing device with transmitting and receiving information, performing standard computing functions through use of a network or local server, interacting and commanding many intelligent peripheral devices around the home or office through wired or wireless means, cellular, Internet Protocol (IP) telephony, handwriting recognition, barcode creating, reading and printing; magnetic stripe creating, reading and printing; electronic mail, which may include audio, text/graphics, and video mass storage device and display features, video input/output, imaging, audio input/output, voice mail capability, voice synthesis, language translation, with text to voice and voice to text capability, and other high speed communication features that may be either wired or wireless. For example, the Mobile Device/Mobile Phone can interact with various intelligent peripherals and appliances, through either wired or wireless means, to print, scan, fax, copy or perform other functions.

### SUMMARY

A variation of the Mobile Device/Mobile Phone is to enable the basic Mobile Device/Mobile Phone, which possesses the electronics and computing power to transmit data to and receive data from either a network server (the network server can be a PC or cloud servers or cloud databases or cloud processors or cloud memory systems) or intelligent peripheral or intelligent appliance through either wired or wireless means, to serve as a transmit and receive hub. Using the computing power resident on the network server a user can perform all standard computing functions from the Mobile Device/Mobile Phone. The Mobile Device/Mobile Phone has a transmitter, receiver, a digital signal processor, controller, display electronics and audio electronics which are available as chips. These chips may be standard integrated circuits or custom built. There can be multiple transmit/receive components built into the Mobile Device/Mobile Phone. The transmit/receive components can operate through either wired such as Ethernet, USB, audio cables, HDMI, or wireless means such as 802.11, cellular, Bluetooth.

Another variation of the Mobile Device/Mobile Phone System is to enable the Mobile Device/Mobile Phone to interact and command many intelligent or Mobile peripheral devices around the home or office through either wired or wireless means and thus serve as a universal keyboard. The Mobile Device/Mobile Phone can assign an identification number to each peripheral or appliance using a cloud server, local server, or local device. With this unique identification number and the processing capability of the network server, the Mobile Device/Mobile Phone can then control that particular appliance or peripheral. All the appliances and peripherals will subscribe to the same protocols such that they will be able to communicate with each other and be able to execute instructions. The intelligent appliances and Mobile Device/Mobile Phones may operate with a common Operating System that may be either proprietary or an industry standard. The intelligent appliances may be connected to a smart intelligent electrical switch or outlet that may control the power to the appliance. In this variation an appliance may be intelligent enabled by plugging the appliance into an intelligent wireless electrical switch and in which the electrical switch is directly plugged into the wall power outlet.

Yet another variation of the Mobile Device/Mobile Phone System is to enable a communication and control scheme of intelligent appliances and peripherals using the Mobile Device/Mobile Phone. The Central multichannel multiplexing transmit/receive device (or Access Point including Wireless Local Area Network Access Points, WiFi Access Points, 802.11 Access Points, or Cellular Access Points) may receive inputs from the local intelligent appliances and route these inputs to the network server/outside world. Conversely, the Central multichannel multiplexing transmit/receive device (or Access Point) may receive inputs from the outside world/network server and route these inputs to the local intelligent appliances. The Central multichannel multiplexing transmit/receive device (or Access Point) is also able to facilitate communication between the local intelligent appliances. The Central multichannel multiplexing transmit/receive device (or Access Point) or functional block may have multiple input and output channels, such that sequential/simultaneous addressing and communication with numerous intelligent appliances and communication paths is possible. The Mobile Device/Mobile Phone in one embodiment may serve as a universal keyboard/command, compute, and control unit within this environment. It is anticipated that the Central multichannel multiplexing transmit/receive device (or Access Point) such as an 802.11abcg Access Point would exist in each home/office environment to facilitate the overall scheme described in this Mobile Device/Mobile Phone system. The Central multichannel multiplexing transmit/receive device (or Access Point) may be built in multiple configurations. The Central multichannel multiplexing transmit/receive device (or Access Point) may be configured with the desired number of input and output channels. The Central multichannel multiplexing modem can be implemented by those knowledgeable in the art utilizing the electronic functional blocks described in this Mobile Device/Mobile Phone system. The Central multichannel multiplexing transmit/receive device (or Access Point) may work in tandem with an embedded transmit/receive device that may exist in each intelligent appliance. Thus, there may exist within the home/office environment a hierarchy of transmit/receive devices:

1. An embedded transmit/receive device may exist in each intelligent appliance.

This embedded transmit/receive device may have multiple inputs/outputs facilitating communication between other intelligent appliances and the central transmit/receive device or directly with the outside world.

2. A central transmit/receive device that will exist in the home/office environment such that it may communicate with numerous intelligent appliances and the outside world.

3. The ability to convert passive electrical outlets and switches that could communicate within this environment and be controlled by a Mobile Device/Mobile Phone or other means.

4. A universal Mobile Device/Mobile Phone that will facilitate the command, compute and control of all intelligent appliances and systems within the home/office environment.

Another variation of the Mobile Device/Mobile Phone System is to enable the Mobile Device/Mobile Phone, which has a speaker and microphone to facilitate interaction between voice recognition software resident on the network server and the Mobile Device/Mobile Phone. The voice recognition software may enable text characters or images to be displayed as they are converted. The software or application may be resident on the Mobile Device/Mobile Phone. Alternatively, the microphone may capture spoken audio and send the spoken audio to a network server for translation. The network server may send the processed recognized audio back to the device. The Mobile Device/Mobile Phone is also capable of outputting sound. It is also able to convert sound to data that can be transmitted to a network server. By using the voice recognition software resident on the network server, Mobile Device/Mobile Phone can convert text data into voice and broadcast voice through a speaker mechanism.

Another variation of the Mobile Device/Mobile Phone System is to enable the Mobile Device/Mobile Phone's display to send data to and receive data from the network server. This display is capable of showing text, graphics or other data.

Another variation of the Mobile Device/Mobile Phone System is to enable the Mobile Device/Mobile Phone to transmit inputs from either the keypad, display or voice inputs (sound) picked up from the microphone to the network server or intelligent peripheral or intelligent appliance for processing (through either wired or wireless means). Thus, one may either send data to software resident on the network server or intelligent peripheral or intelligent appliance through the keypad, through voice commands, or through the display by touching the screen.

Another variation of the Mobile Device/Mobile Phone System is to enable the Mobile Device/Mobile Phone to receive and transmit information through a modem, a telephone line, an Ethernet line or other form of data communication. These inputs and outputs are then processed by a network server or local server and are relayed back to the Mobile Device/Mobile Phone and/or the display. The Mobile Device/Mobile Phone can use its wireless radio to transmit data to and receive data from a network server or “intelligent” peripheral or appliance through either wired or wireless means. In this scenario, the network server may perform any computation that is necessary. Intelligent peripherals and appliances will interact with the Mobile Device/Mobile Phone through either wired or wireless means.

For example, wireless communication may be achieved through either radio frequency, in which line of sight is not required, or through infrared, in which line of sight is required. For wireless operation, a radio frequency transmit/receive device or functional block can be built into the Mobile Device/Mobile Phone. The radio frequency transmit/receive device or functional block allows the Mobile Device/Mobile Phone, which uses the computing power of the network server, to interface and control other intelligent peripherals or intelligent appliances. The radio frequency modem can be either single or multi-channel This means that the radio frequency transmit/receive device or functional block which is built into the Mobile Device/Mobile Phone can receive all of its input from the Mobile Device/Mobile Phone or it can receive many different inputs from various intelligent appliances and peripherals simultaneously. The radio frequency may be in any range that is FCC approved, including spread spectrum.

Another variation of the Mobile Device/Mobile Phone System is to enable the Mobile Device/Mobile Phone to be connected to a local area network or wide area network, including the Internet, through either wired or wireless means, to receive inputs of text and/or voice and to send outputs of text or voice depending on the user's choice. Voice sent to a network server could be stored as a data file.

Another variation of the Mobile Device/Mobile Phone System is to enable the Mobile Device/Mobile Phone to work in tandem with a network server to receive text or voice data and process these inputs for audio output. The primary computing power/protocols and software reside on the server.

Voice includes spoken, as well as, other audio and or audible tones inclusive of music/sound.

Another variation of the Mobile Device/Mobile Phone System is to enable the Mobile Device/Mobile Phone to have options and attachments added to it. For instance, the Mobile Device/Mobile Phone can have more processing power such that it can perform basic computations and will not have to directly communicate with the network server to perform certain functions. For example, the Mobile Device/Mobile Phone can possess more processing power so that it can assign an identification number to various appliances and peripherals, recognize various appliances and peripherals and so that it can assign instructions for these appliances and peripherals to execute. Additionally, other features such as data storage can be added to the Mobile Device/Mobile Phone. A module or storage device can be built into the Mobile Device/Mobile Phone to record and store data and voice. For example, this can be accomplished by using a PCMCIA card. The Mobile Device/Mobile Phone can also be connected to a mouse, CD-ROM, printer, CRT/TV by either wired or wireless means. As an option a scanner may interface with the Mobile Device/Mobile Phone so that documents can then be sent to the network server for further processing.

An variation of the Mobile Device/Mobile Phone System is to enable a user to use voice commands to access the Internet and at the same time command intelligent peripherals and appliances through either wired or wireless means.

Another variation of the Mobile Device/Mobile Phone System is to combine transmitting and receiving information, performing standard computing functions through use of a network or local server, interacting, and commanding many intelligent peripheral devices around the home or office through wired or wireless means, telephony, handwriting recognition, barcode creation, reading and printing; magnetic stripe creating, reading and printing; electronic mail, which may include audio, text/graphics, and video; mass storage device and display features, video input/output, imaging, audio input/output, voice mail capability, voice synthesis, language translation with text to voice and voice to text capability, and other high speed communication features that may be either wired or wireless into one device.

Yet another variation of the Mobile Device/Mobile Phone System is to enable a user to translate voice in one language to text or voice in another language. This can be accomplished either by using language translation modules which fit into the Mobile Device/Mobile Phone or by using the software capabilities of the local or network server. The output can be in audio, display/video format or the Mobile Device/Mobile Phone can command an intelligent peripheral such as a printer to convert this output into hard copy format.

Yet another variation of the Mobile Device/Mobile Phone System is to enable a user to translate text in one language to text or voice in another language. This can be accomplished by either using language translation modules which fit into the Mobile Device/Mobile Phone or by using the software capabilities of the local or network server. The output can be in audio, display/video format, or the Mobile Device/Mobile Phone can command an intelligent peripheral such as a printer to convert this output into hard copy format.

Yet another variation of the Mobile Device/Mobile Phone System is to enable users to communicate with and command the Mobile Device/Mobile Phone remotely, through either the Internet or through a data communication line such as a telephone line.

Still another variation of the Mobile Device/Mobile Phone System is to enable a user to command the Mobile Device/Mobile Phone through voice commands. As an example, a user could dictate a message to the Mobile Device/Mobile Phone in any language.

Yet another variation of the Mobile Device/Mobile Phone System is to enable the Mobile Device/Mobile Phone to be able to interact with other intelligent peripherals or intelligent appliances. This could involve, for instance, interacting with an intelligent television to output the keystrokes that are typed on the Mobile Device/Mobile Phone.

Yet another variation of the Mobile Device/Mobile Phone System is to enable the Mobile Device/Mobile Phone to interact with other devices through either wired or wireless means.

Still another variation of the Mobile Device/Mobile Phone is to enable the device to work in conjunction with a local or network server to receive text, voice, or other data and process these inputs for either editing, audio, video, and other data output.

A variation of the Mobile Device/Mobile Phone is to use the computing power of the local or network server to perform complex tasks. As an example, a local server may be a personal computer.

Another variation of the Mobile Device/Mobile Phone is that it has a built-in communication functional block such as a high speed transmit/receive device. This high speed transmit/receive function enables the Mobile Device/Mobile Phone to access the network at very high data rates that are necessary in order to transmit and receive data from other devices or from the network. The ability to transmit/receive may reside within the keyboard or be external to it. This access to the Internet, the Intranet, public cloud, private cloud, cable network, wireless network, or other networks may be via wired or wireless means. As an example, the Mobile Device/Mobile Phone may receive/transmit through a wireless satellite network. It is anticipated that many intelligent appliances will have a common transmit/receive function that would operate under common industry standards and protocols. These standards would apply both for the hardware and the software implementation. These transmit/receive functional blocks will be part of the hardware of many intelligent appliances/devices.

Another unique feature of the Mobile Device/Mobile Phone is that it could serve as the base station or as a handset for telephony with the ability to operate with multiple telephone handsets. This will enable the user to transmit and receive using voice and selectively display as needed. The telephony may be either wired or wireless.

In accordance with another feature of the Mobile Device/Mobile Phone System the Mobile Device/Mobile Phone may have options and other devices added on to it. For example, extra data/mass storage devices such as an SD card, Micro-SD card, or flash memory card can be connected to the Mobile Device/Mobile Phone. This will allow local archival of confidential and sensitive messages and data, while at the same time will enable the user to access certain types of data since it is resident locally rather than on the network.

Another embodiment of the Mobile Device/Mobile Phone is that it can take inputs of written word or spoken word and output a synthesized voice through its speakers. The database that contains the intonation and phonetic character of the voice can reside either in specialized modules which fit into the Mobile Device/Mobile Phone, or on the local or network server, or on the Mobile Device/Mobile Phone itself. Various synthesized voices can be selected ranging from your own to someone else's. As an example, you could record some selected sounds and it would recognize your voice patterns and synthesize it. This allows text to be outputted as speech in your own voice or another voice. The voice patterns may be downloaded from an Internet server or exchange The voice recognition system may perform functions including accessing a plurality of Internet websites and aggregating responses to deliver the results to the Mobile Device/Mobile Phone. This may include searching an Internet website, aggregating product prices, or finding product information.

Another aspect of the Mobile Device/Mobile Phone System is to enable the Mobile Device/Mobile Phone to capture images from books, blackboards, white boards, paper easel boards, and other displays to either print, process, transmit, or store for future use. As an example, the Mobile Device/Mobile Phone may have an image capture capability through a digital camera. The image capture capability may either be built-in, or be in an optional attachment or be part of a peripheral device including a higher megapixel camera that works in tandem with the Mobile Device/Mobile Phone. In this scenario, the Mobile Device/Mobile Phone can digitize the text/drawings or other information displayed on a book, sheet of paper, blackboard, white board, paper easel, or other forms of display for archival, further processing, or transmission via a network to other locations/devices. This content may be stored on a network or cloud server for access from other devices. The content may further be synchronized and pushed to other devices automatically.

Another aspect of the Mobile Device/Mobile Phone System is to enable the Mobile Device/Mobile Phone to use its digital camera, which can be built into the Mobile Device/Mobile Phone, to digitize an image. This image can then be converted to either voice or text. As an example, if the digital camera took a digitized image of a page in a book which might be inconvenient to scan in through a page-feed scanner, as opposed to a flat-bed scanner, it could then convert this image into text and store this as a text document, process this information further, could convert the image into voice for further processing, or output the voice through the speakers.

Another aspect of the Mobile Device/Mobile Phone System is to automatically add subtitles/text to a video clip, which may be displayed continuously or frame by frame. The Mobile Device/Mobile Phone converts the voice from the video clip into text and is able to display this text/subtitle on a CRT or display in any or multiple languages. As an example, this option would be of great benefit to individuals who are hearing impaired. Another example of the benefit of this textual display is the ability for those watching a movie in one language to hear the sound in that language but view the text/subtitles on the screen in a different language.

Another variation of the Mobile Device/Mobile Phone System is to recognize alpha-numeric text to create barcodes. The Mobile Device/Mobile Phone can also read barcodes to create alpha-numeric text. With a barcode reader attachment which may be wired or wireless the Mobile Device/Mobile Phone serves as a vehicle either to print barcode labels or to store the digitized barcode information for further processing.

Another aspect of the Mobile Device/Mobile Phone System is to enable the Mobile Device/Mobile Phone to serve as a point of sale terminal that can read magnetically coated information from credit cards. In this configuration, the Mobile Device/Mobile Phone will have a will have a built-in feature or an external attachment where a credit card can be swiped across a reader that would be able to read magnetically coated information from the credit card for transmission, verification, transaction, and confirmation. The Mobile Device/Mobile Phone, as an example, may be used in stores to conduct transactions. By interacting, and commanding an intelligent printer, the Mobile Device/Mobile Phone would be able to print. It is also anticipated that the Mobile Device/Mobile Phone would be able to facilitate home banking, home shopping via this feature with the ability to provide printed receipts or storage of relevant information on a local and/or network server.

Another aspect of the Mobile Device/Mobile Phone System is to enable a user to input handwritten text in any specific language and have the Mobile Device/Mobile Phone output text in the same or another language in a standardized format in any font for either display, transmission, or further processing. The Mobile Device/Mobile Phone can perform the reverse operation of converting standardized text in any specific language to handwritten text in the same or a different language. It is anticipated that independent third parties would develop handwriting pattern recognition algorithms based on sampling and digitizing various types of handwriting patterns in a specific language with the object of creating a lookup table that would provide a corresponding standardized textual equivalent. These types of handwriting recognition databases may be created for English and all other languages with a textual equivalent in each language. Cross-linking of these different handwriting language databases allows for language translation of handwritten text into the same language or another language's textual equivalent. As a result, it is also possible to have the conversion of handwritten text in one language to handwritten text in another language. If the user desires to use his own handwriting for output, the user can input a sample document of his handwriting to the Mobile Device/Mobile Phone. The Mobile Device/Mobile Phone can then store the handwriting pattern and various handwritten letters of the alphabet in a look-up table or database. The Mobile Device/Mobile Phone can use this database and optical character recognition/handwriting pattern recognition algorithms to output a text document in the user's handwriting. It is also possible to convert handwritten text into voice and the reverse process of voice into handwritten text in the same or a different language. The software, protocols, handwriting recognition algorithms and databases to perform this function may reside in the Mobile Device/Mobile Phone or on a local or network server which the Mobile Device/Mobile Phone interacts with.

Another aspect of the Mobile Device/Mobile Phone System is to provide complete portability such that the Mobile Device/Mobile Phone can be used locally or globally. A Mobile Device/Mobile Phone may be personalized and used anywhere in the world by plugging into a communication line to access various intelligent appliances, devices, wireless local area networks, and cellular networks.

Another aspect of the Mobile Device/Mobile Phone System is to enable handheld personal computers and other similar portable or desktop devices to incorporate some or all of the features claimed for the Mobile Device/Mobile Phone.

Another aspect of the Mobile Device/Mobile Phone System is that an embedded multichannel multiple input and multiple output (MIMO) transmit/receive device or functional device may be incorporated into various intelligent appliances including a handheld PC. The embedded transmit/receive function allows the communication among various intelligent appliances and is configured to work in tandem with a Central multichannel multiplexing transmit/receive device (or Access Point). The Central multichannel multiplexing transmit/receive device (or Access Point) may have operate on multiple communication bands at frequencies including 2.4 Ghz and 5 Ghz, provide multiple input and multiple output ports, ethernet connectivity, USB 1.0, USB 2.0, USB 3.0 wired connectivity, and operate using 802.11a, b, c, n, or other protocols.

Another aspect of the Mobile Device/Mobile Phone System is that a Central multichannel multiplexing transmit/receive device (or Access Point) will be an integral part of a local or wide area network working as a central controller or communications server. In this capacity, it is able to control a number of intelligent client appliances within its local sphere of control or Radio Frequency (RF) range. In this capacity as a communications server this unit unlike a PC or other standard servers may not have full range of computing capabilities but a limited set that enables it to serve in sequencing and scheduling the transmit/receive functions.

Another aspect of the Mobile Device/Mobile Phone System is to define a transmit/receive functional block that can be single input or multiple input with either a single or multiple outputs that may be accessed sequentially or simultaneously. Conceptually the transmit/receive functional block may be executed in two forms: 1) as an embedded transmit/receive function that would reside in an intelligent appliance or device 2) as a central multichannel multiplexing unit that could work in association with a number of embedded transmit/receivers, to schedule and sequence communication traffic.

Another aspect of the Mobile Device/Mobile Phone System is that the embedded transmit/receive function and the central multichannel multiplexing transmit/receive functional block concept can be executed at a printed circuit board level or as a multichip single package or as a single chip monolithic IC solution. This solution can be an integral part of every intelligent appliance, personal computer, servers, and other devices to enable intelligent appliances to communicate within a local or wide area network or across the Internet.

Another aspect of the Mobile Device/Mobile Phone System is to enable the ubiquitous wall electrical sockets, switches, sensors, and other similar devices to be turned into intelligent units capable of being controlled by the Mobile Device/Mobile Phone and functioning Mobilely within an intelligent local or wide area network. This is accomplished by an embedded radio frequency controller. The functional block level concept for executing this radio frequency controller as a single chip monolithic IC solution is outlined.

The Mobile Device/Mobile Phone System, objects and features thereof will be more readily apparent from the following detailed descriptions and appended claims when used in conjunction with the drawings.

### BRIEF DESCRIPTION OF THE DRAWINGS

FIG. 1 is a system level input/output configuration block diagram of the Mobile Device/Mobile Phone. In addition to its normal keyboard functions, display, and other features, the Mobile Device/Mobile Phone has the ability to interface with a local wireless network to a cellular network, to other IP networks, to ethernet or to other data communication paths, either by wired or by wireless. Note that all arrows on FIG. 1 can signify either wired or wireless data communication paths. The Mobile Device/Mobile Phone may have a built-in embedded transmit/receive device/function or may interface with an external transmit/receive device either of which may be wired or wireless, either radio frequency or infrared. The input/output functions of the Mobile Device/Mobile Phone described in this figure can be executed by those knowledgeable in the art and reduced to actual practice.

FIG. 2 is a detailed block diagram of the Mobile Device/Mobile Phone that highlights the display, telephony, transmit/receive function, and other specialized functions which can be implemented as hardware and/or software by those knowledgeable in the art and reduced to practice.

FIG. 3 is an embedded transmit/receive function diagram that describes one of the possible schemes and detailed functional blocks that would be part of an embedded transmit/receive function. It is anticipated that many intelligent appliances will have an imbedded transmit/receive function that complies with established industry standard hardware and software protocols that are expected to emerge. The figure shows multiple inputs and multiple outputs (MIMO) that would allow each intelligent appliance to sequentially/simultaneously interface with more than one intelligent appliance or Mobile Device/Mobile Phone. The Mobile Device/Mobile Phone itself is an intelligent device that would have the same embedded transmit/receive function.

FIG. 4 is a simplified block diagram showing a method to transmit, receive and identify that would allow the coding of information, transmitted by an intelligent device such that this information received by another device can be decoded and identified to its unique source from which the data was transmitted.

FIG. 5 shows a global scheme of how multiple intelligent devices and the Mobile Device/Mobile Phone coexist in an office/home environment with each other, the PC/server, the network server, and the outside world. This drawing shows a Central multichannel multiplexing transmit/receive device (or Access Point) that is able to receive inputs from various intelligent appliances and channel the routing and transmission for efficient communication between various intelligent appliances. Note that all lines represent either radio frequency paths, infrared paths, or another form of wired or wireless data communication.

FIG. 6 shows how the central multichannel multiplexing transmit/receive device/function could be implemented as a hardware system in a box or as an integrated system level silicon solution in the form of a single chip/multi-chip single packaged integrated circuit. Many combinations of inputs and outputs are possible as shown in FIG. 6. Note that the transmitter/receiver may be either wired or wireless.

All the figures are for illustrative purposes and the number of inputs and outputs is not to be construed as limited by the examples shown in the Figures. In addition, the feature of programmation provides for added flexibility. Further, each of the input/output channels could be hardwired designed or software programmable to interface with various types of input/output data communication lines.

FIG. 7 shows how the ubiquitous electrical outlet and the electrical switch could be made to be intelligent by having an embedded radio frequency controller. The embedded radio frequency controller allows the Mobile Device/Mobile Phone and or/other intelligent appliances to efficiently and intelligently interact with the electrical outlet and the electrical switch. The Mobile Device/Mobile Phone in conjunction with the electrical outlets may operate in a licensed or unlicensed communication band such as 2.4 GHz or 5 GHz. The electrical wiring may serve as an antenna. By extension this concept may be applied to other appliances that are either active or passive. In addition, the existing base of electrical outlets/switches could have an intelligent plug-in module to turn these hitherto passive outlets into active intelligent outlets/switches. The embedded RF controller may have programmable features built-in to provide added options. Note that the antenna may be part of the intelligent electrical switch or intelligent electrical socket or intelligent sensor or it may use the internal wiring of the house as an antenna. The electrical outlet may be enabled with a local wireless local area network transmit and receive using 802.11 or WiFi or with a wireless wide area network transmit and receive unit such as a cellular GSM and UMTS radio.

FIG. 8, FIG. 9, FIG. 10, FIG. 11, and FIG. 12 show additional block diagrams of a Mobile Device/Mobile Phone system. FIG. 8 shows a Mobile Device/Mobile Phone communicating using an inside line path such as Ethernet, wireless local area network, 802.11, Bluetooth. FIG. 8 further shows the Central MMTR communicating to network server using an outside path such as cellular, wireless wide area networks, or other means.

FIG. 9 shows the Mobile Device/Mobile Phone connected to a printer using a network and protocol such as Bluetooth or WiFi. FIG. 10 shows the Mobile Device/Mobile Phone connected to a television using a network and protocol such as Bluetooth, WiFi, or infrared.

FIG. 11 shows a connection to various intelligent appliances using a Central multichannel multiplexing transmit/receive. FIG. 12 shows a central MMTR or Access Point connected to local Mobile Devices/Mobile Phones using a first communication network such as Bluetooth or WiFi and the central MMTR or Access Point connected to another network using Ethernet or Cellular. In one embodiment, this may allows traffic to be taken off a wireless network and placed onto to a wired network.

FIG. 13, FIG. 14, FIG. 15, and FIG. 16 show various examples of the home automation and home control system using a mobile device to control door locks, electrical outlets, intelligent appliances, motion sensors, IP enabled video cameras, thermostat. These appliances may be controlled by an application on a Mobile Device/Mobile Phone. FIG. 13 shows multiple Mobile Devices/Mobile Phones connected to the home using a cloud network server. FIG. 14 shows a Mobile Device/Mobile Phone controlling various appliances using a local wireless network. FIG. 15 shows various icons on the display of a Mobile Device/Mobile Phone with status updates. FIG. 16 shows various rules, configurations, settings, and history related to specific items and locations within the home.

### DETAILED DESCRIPTION OF ILLUSTRATIVE EMBODIMENTS

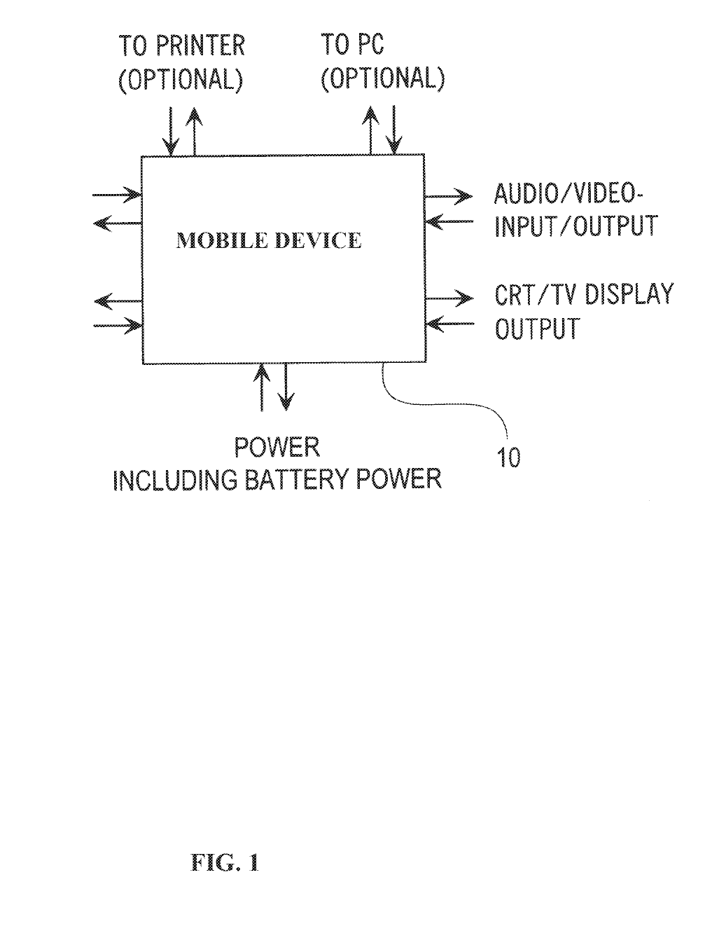

Referring now to FIG. 1, the Mobile Device/Mobile Phone may have multiple inputs and multiple outputs (MIMO) which may be connected through either wired or wireless means. Additional inputs and outputs may be added as needed to make the Mobile Device/Mobile Phone a multifunction universal keyboard. The added features may be external or built-in. The Mobile Device/Mobile Phone may have an optional built in scanner mechanism or application coupled to a built-in camera on the device such that the Mobile Device/Mobile Phone can be used as a handheld scanner. This built-in scan mechanism may use the digital camera the Mobile Device/Mobile Phone to allow for page scanning, or other document scanning by dragging or sweeping the Mobile Device/Mobile Phone edgewise, across the document. The scanned images may be displayed on a built-in screen of the Mobile Device/Mobile Phone or transmitted for further processing/display on other intelligent devices.

Referring, to FIG. 1, the Mobile Device/Mobile Phone may also have a built-in ports for various devices using ports such as a microphone port, USB port, micro USB port.

Referring to FIG. 1, the Mobile Device/Mobile Phone may have a built-in microphone and speaker to facilitate speaking directly into the Mobile Device/Mobile Phone as we normally do into a telephone handset and also listening to its sound output. In addition, the Mobile Device/Mobile Phone may have optional attachments to provide other standard telephony features.

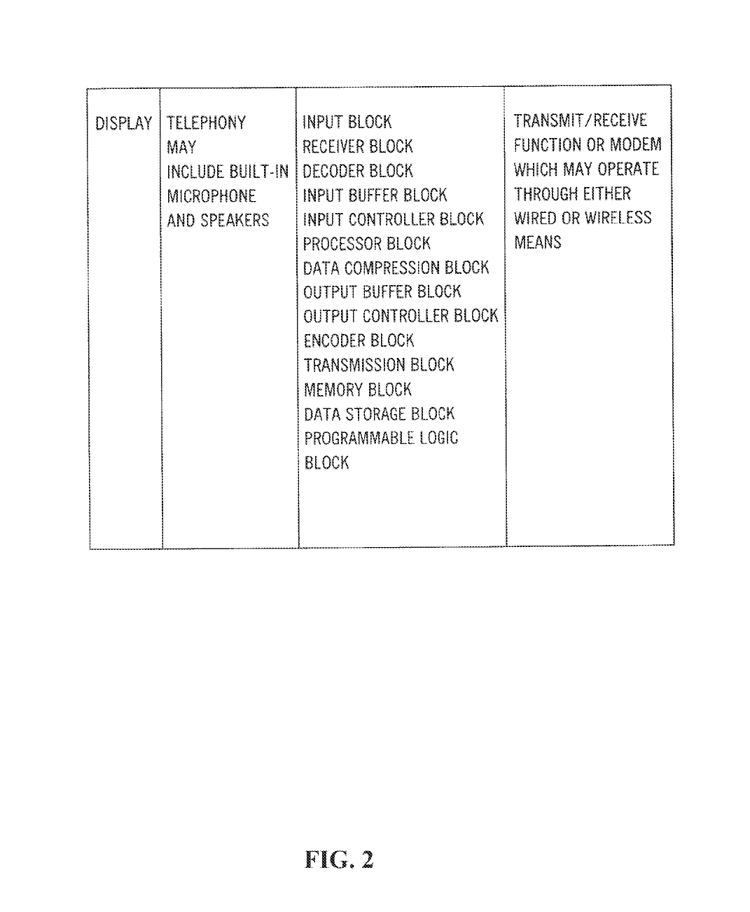

Referring now to FIG. 2, the Mobile Device/Mobile Phone comprises a keyboard, a display, a microphone, a speaker, telephony, transmit/receive device, with optional input/output ports. The telephony feature may work either with an intelligent telephone/base station or with a local or network server, IP network, or cellular network. Data may be inputted via the keyboard, a touch screen display, or through voice. Processing may be performed within the Mobile Device/Mobile Phone or by the local or network server or other intelligent devices.

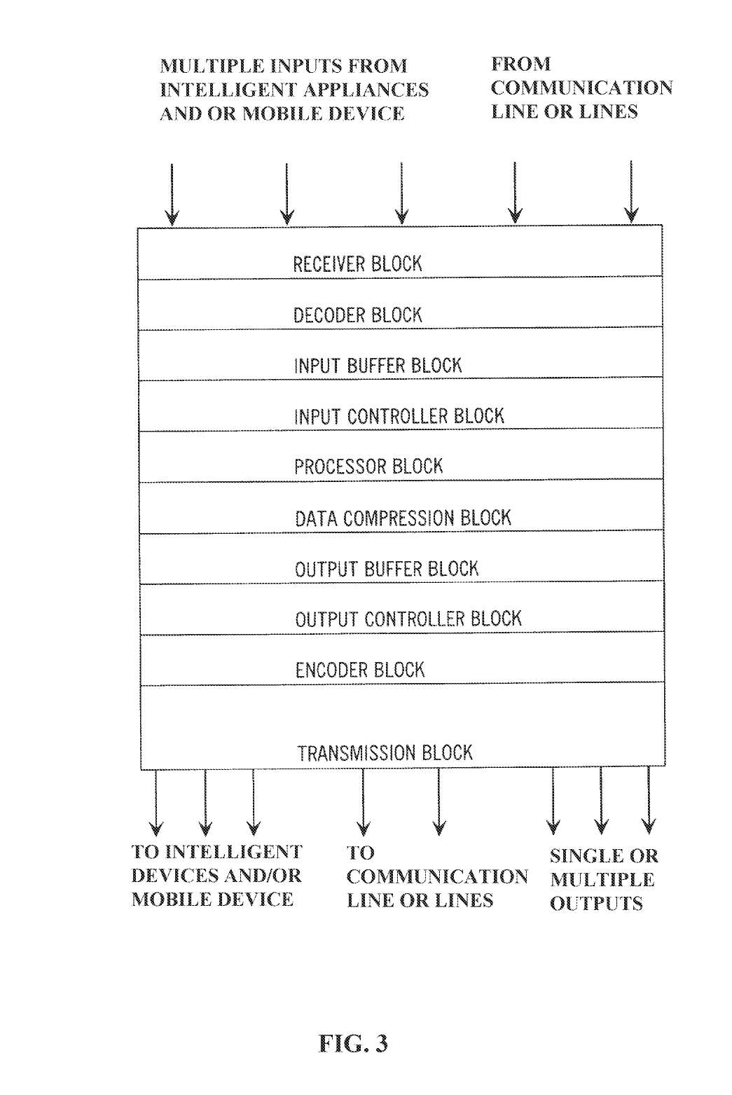

Referring now to FIG. 3, illustrates the Central multichannel multiplexing transmit/receive device (or Access Point), and the electronics/components of the Central multichannel multiplexing, transmit/receive device: an input block, receiver block, decoder block, input buffer block, input controller block, processor block, data compression block, output buffer block, output controller block, encoder block, and transmission block. Shown in this Figure are multiple inputs from various intelligent appliances and/or the Mobile Device/Mobile Phone. The input block consists of multiple channels that will route the data to the receiver. The receiver electronics is capable of receiving data and identifying the source of each data packet. The receiver block is capable of receiving inputs simultaneously or sequentially from various sources. The data received from the receiver block may be in an encoded form in which case the decoder block decodes the data for further processing. Simultaneous and/or sequential data packets from multiple sources are stored and queued for further processing in the input buffer block. The input controller block decides which packet of information needs to be processed next and sends the appropriate packet of data for further processing by the processor block. After the data is processed by the processor, it is now ready for transmission. However, to achieve high speed transmission the data compression block compresses the data. The data is now stored in the output buffer block awaiting specific instructions by the output controller block. The encoder block encodes the packet of data such that it reaches the unique appliance or device for which it is intended. The transmission block transmits the data in sequence to the intended appliance or device or for further processing via a standard communication line or a RF data path. Those knowledgeable in the art can implement each of the specific functional blocks utilizing standard electronic components or custom components. These components may be configured to perform parallel processing for various data streams. For example, when four channel capabilities are desired, four separate processor components may be used or a four channel monolithic processor specifically designed for this purpose may be used.

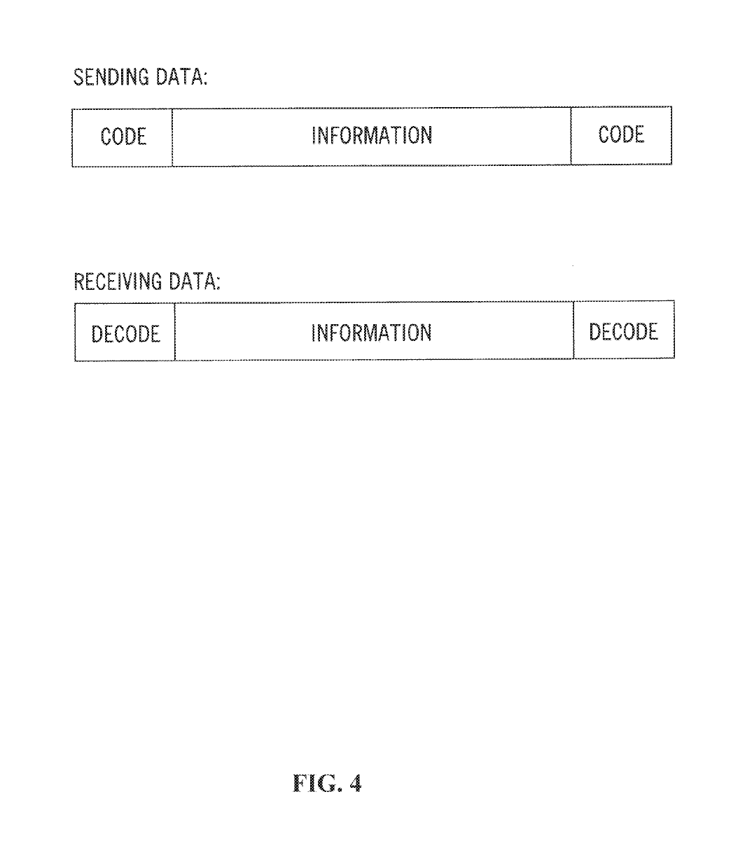

Referring now to FIG. 4, this figure shows a simplified block diagram by which an identifying string could be attached to real data. This identifying string will precede actual data transmission and will also be sent after the actual data transmission. In other words, packets of real data are embedded in between two identifying strings. These identifying strings uniquely define the source of the data and the destination of the data.

Thus the intelligent appliance sending the data is uniquely identified and the intelligent appliance receiving the data is uniquely identified. The periodicity at which the identifying strings could be appended to actual data will depend on the level of accuracy, security, and the speed of transmission desired. The actual data may be encrypted. These protocols ensure that the correct intelligent appliance is being addressed at all times. In addition, the user may be able to set a unique identification number and addressing sequence of his choice for each intelligent appliance or device.

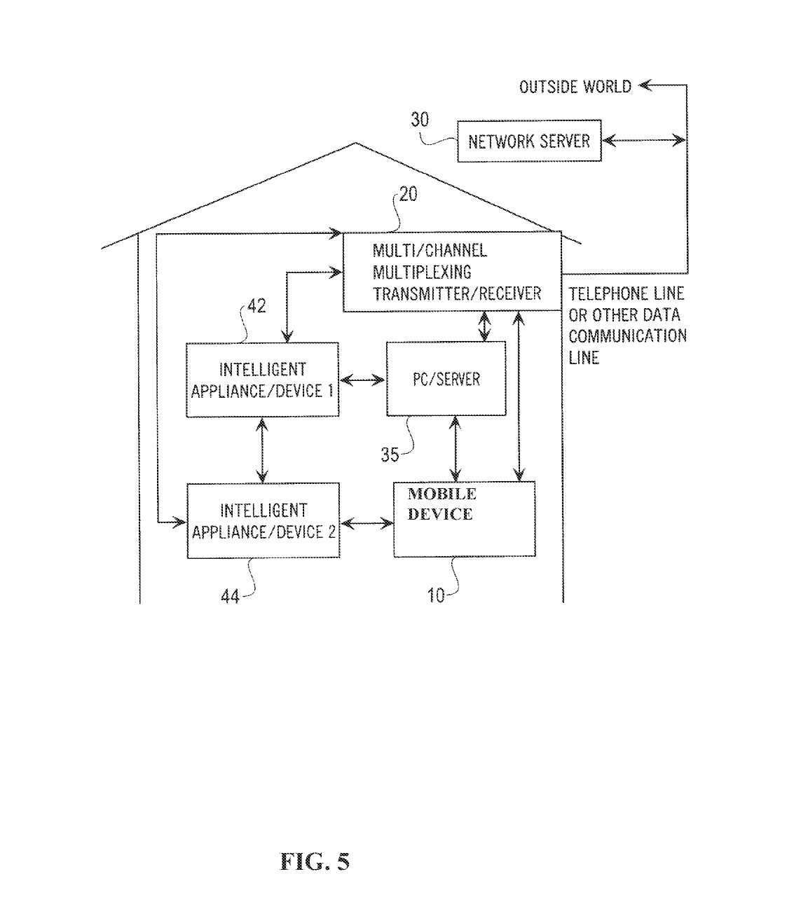

Referring now to FIG. 5, this figure shows a system level scheme that describes the various communication and data paths between various intelligent appliances, the Central multichannel multiplexing transmit/receive device (or Access Point/Switch), the local or network server, and the Mobile Device/Mobile Phone. When sending data, intelligent appliances and devices are expected to subscribe to common, industry standard protocols that establish the identity of each intelligent appliance/device and the unique way to address each intelligent appliance/device. These protocols ensure that the correct intelligent appliance/device is being addressed at all times. In addition, the user may be able to set a unique identification number and addressing sequence of their choice for each intelligent appliance/device.

The Central multichannel multiplexing transmit/receive device (or Access Point) may receive inputs from the local intelligent appliances and route these inputs to the network server/outside world. Conversely, the Central multichannel multiplexing transmit/receive device (or Access Point) may receive inputs from the outside world/network server and route these inputs to the local intelligent appliances. The Central multichannel multiplexing transmit/receive device (or Access Point) is also able to facilitate communication between the local intelligent appliances. The Central multichannel multiplexing transmit/receive may have multiple input and output channels such that sequential and simultaneous addressing and communication with numerous intelligent appliances and communication paths is possible.

The Mobile Device/Mobile Phone is one element that would serve as a universal keyboard/command and control unit within this environment. It is anticipated that the Central multichannel multiplexing transmit/receive device (or Access Point) would exist in each home/office environment to facilitate the overall scheme described in this Mobile Device/Mobile Phone system. The Central multichannel multiplexing transmit/receive device (or Access Point) may be built in multiple configurations. The Central multichannel multiplexing transmit/receive device (or Access Point) may be configured with the desired number of input and output channels. The Central multichannel multiplexing transmitter/receiver can be implemented by those knowledgeable in the art utilizing the electronic functional blocks described in this Mobile Device/Mobile Phone system.

The Central multichannel multiplexing transmit/receive device (or Access Point) may work in tandem with an embedded transmit/receive device that may exist in each intelligent appliance. Thus, there exists within the home/office environment a hierarchy of transmit/receive devices:
1. An embedded transmit/receive device may exist in each intelligent appliance. This embedded transmit/receive device may have multiple inputs/outputs facilitating communication between other intelligent appliances and the central transmit/receive device or directly with the outside world.
2. A Central multichannel multiplexing transmit/receive device (or Access Point) that will exist in the home/office environment such that it may communicate with numerous intelligent appliances and the outside world.
3. The ability to convert passive electrical outlets and switches that could communicate within this environment and be controlled by an Mobile Device/Mobile Phone or other means.
4. A universal Mobile Device/Mobile Phone that will facilitate the command, compute and control of intelligent appliances and Internet Protocol based systems within the home/office environment and Internet websites.

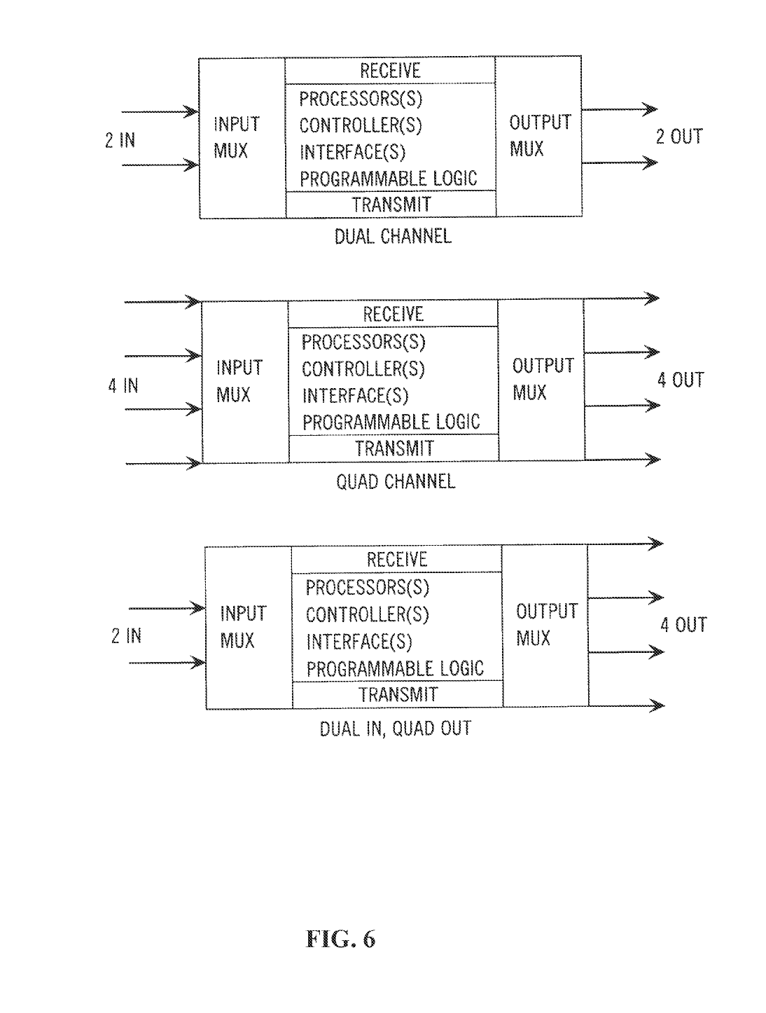

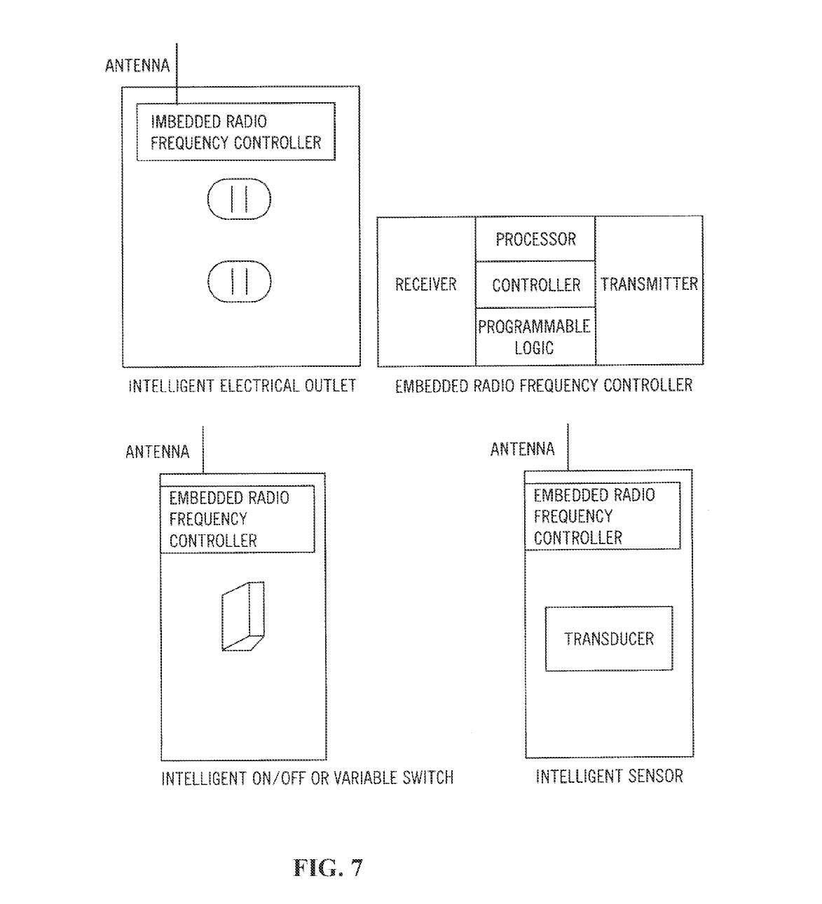

Referring now to FIG. 6, which describes a multichannel multiplexing transmit/receive device, the transmit/receive controller electronics block diagram can be implemented by those skilled in the art with either standard or custom electronics. The entire controller electronics may be a single chip integrated circuit. It is anticipated that all intelligent appliances would utilize this block diagram as a universal and requisite embedded feature. This embedded transmit/receive function may come in multiple configurations of inputs and outputs. In dual channel configuration, the multiplexing transmit/receive device has two inputs and two outputs. This will allow an intelligent appliance to sequentially or simultaneously be addressed by the Mobile Device/Mobile Phone for either sequential or simultaneous output. Similarly, this same block diagram concept is executable for a Central multichannel multiplexing transmit/receive device (or Access Point/Switch).

Referring now to FIGS. 3, 4, 5, and 6, the following examples serve to demonstrate the workings of the Mobile Device/Mobile Phone, intelligent appliances, and the central multichannel multiplexing transmitter/receiver:

### Example 1

A telephone call may be initiated or received using the Mobile Device/Mobile Phone. A user may activate the Mobile Device/Mobile Phone and put it into the telephony mode. Immediately, the Mobile Device/Mobile Phone is in RF communication with the central multichannel multiplexing transmitter/receiver located in the local area network. The central multichannel multiplexing transmitter/receiver will connect with the outside line and complete the connection. Let us say at some point in the conversation the capability of the local server or network server is desired. The Mobile Device/Mobile Phone can send a RF command to the central multichannel multiplexing transmitter/receiver to bring the server on-line and into the communication loop. The server may be used to record the conversation or to have the conversation translated into another language using the extensive language translation capabilities resident on the local/network server. Conversations could be conducted in two or more languages.

### Example 2

If at any time during the conversation a printout is desired an intelligent printer can be activated by the Mobile Device/Mobile Phone to initiate and execute the job. This is accomplished by sending an RF signal from the Mobile Device/Mobile Phone to the intelligent printer via the central multichannel multiplexing transmitter/receiver. The intelligent printer is now in the loop and is executing the tasks immediately or queuing and scheduling the task.

### Example 3

The text, graphics, and video may be activated by the Mobile Device/Mobile Phone and viewed on a built-in screen or viewed on an Mobile TV or intelligent TV screen by patching the Mobile TV or intelligent TV screen into the communication loop. The Mobile Device/Mobile Phone may change the channel, volume, content, on the television. The Mobile Device/Mobile Phone may send stream content to the Mobile TV or intelligent TV. The mobile device may use infared to control the television or wireless TCIP/IP based protocol or a wireless IP protocol in conjunction with a local or network server to control the television.

### Example 4

Multichannel capability and the ability to multiplex the inputs/outputs sequentially or simultaneously for use by a number of intelligent appliances is possible. This multichannel multiplexing capability may exist within each intelligent appliance. The ability to incorporate this feature is driven by need and cost. The advantage is that this feature allows each intelligent appliance and the whole local area network to be used efficiently and effectively by allowing queuing and scheduling of various tasks. The queuing and scheduling tasks is real time and there may be different levels of queuing and scheduling capabilities resident in each intelligent appliance and the local area network.

Certain levels of queuing and scheduling capabilities may exist in the intelligent appliance, another level of capabilities may exist in the central multichannel multiplexing transmitter/receiver and yet another level of capability may exist in the local or network server. The level of capability to queue, schedule, process, receive, and transmit data depends on the number of input and output channels, the size of the data buffer and whether the inputs and outputs can be multiplexed. It is also possible to define and dedicate certain channels for various pre-defined or programmable tasks only. The embedded transmitter/receiver function and the central multichannel multiplexing transmitter/receiver can be built to have a combination of various input and output channels with and without multiplexing capability. The basic concept of how these electronic functional blocks can be executed at either the board level or chip level is described. As an example, a quad-in and quad-out transmitter/receiver can have one channel dedicated for telephony, another channel dedicated for TV, another channel for printers, and a channel for security or it is possible to have certain channels multiplexed for use by a number of intelligent appliances.

### Example 5

The transmission/reception is within the FCC prescribed frequency domain for intelligent appliances. The transmitter/receiver electronics and ICs are designed to conform to the prescribed standards. However, within the local or wide area network significant RF traffic from numerous intelligent appliances may be present with the potential for crosstalk and other problems. To avoid this crosstalk, packets of RF data sent by each intelligent appliance are coded and transmitted in such a way that periodically there will be an identifying string of data that clearly defines the source of the data and the destination. The periodicity of this identifying string data, the length and complexity of this identifying string data, and the encryption of actual data is driven by the level of accuracy and the level of security desired. This ability to encode and decode identifying strings from each appliance allows multiple intelligent appliances to use the same RF frequency domain and co-exist within a local area network. The implementation of this concept requires the hardware described and a pre-defined set of software protocols that may be either industry standard or custom.

### Example 6

The central multichannel multiplexing transmitter/receiver may either connect with the outside world through the wire or by wireless or satellite means. It is possible that this central multichannel multiplexing transmitter/receiver may communicate in one defined frequency domain within the local or wide area network with all intelligent appliances that are part of this network and at a same or different frequency domain with the outside world. By extension the reverse concept is also claimed. In this scenario, where there may be a need for two different frequencies of communication the transmitter/receiver electronics and chip level solutions can be designed to accommodate for this requirement.

### Example 7

Referring now to FIG. 7, the figure consists of an intelligent electrical outlet with a built-in radio frequency controller. The radio frequency controller has the ability to receive inputs and transmit Output such that the electrical outlet can be controlled by the Mobile Device/Mobile Phone or other means. The radio frequency controller consists of the transmit/receive function and the control function which includes the ability to turn the outlet on and off and perform other variable and programmable control functions. The radio frequency controller consists of a receiver, a processor, controller, programmable logic, and a transmitter. The radio frequency controller electronics may be implemented by those skilled in the art using, either standard or custom electronics. The entire controller electronics may be implemented as a monolithic single chip integrated circuit. A block diagram concept of how this embedded RF controller can be implemented at a chip level is shown in FIG. 7. The radio frequency controller can be incorporated on all new electrical outlets and switches to be made in the future such that they are all intelligent electronic outlets and intelligent electrical switches. Alternatively, a plug-in module may be configured to make existing electrical outlets and electrical switches intelligent. Additionally, this concept of an embedded RF controller may be extended to other sensors that would sense such things as light, temperature, and pressure, smoke, to name a few. The radio frequency controller consists of the transmit/receive function and the control function which includes the ability to turn the switch on and off. It is possible to assign a unique identification to each electrical outlet and each electrical switch to uniquely address and control these units using the Mobile Device/Mobile Phone.

More detailed examples of the aspects of the present Mobile Device/Mobile Phone System will now be described.

### Example 8

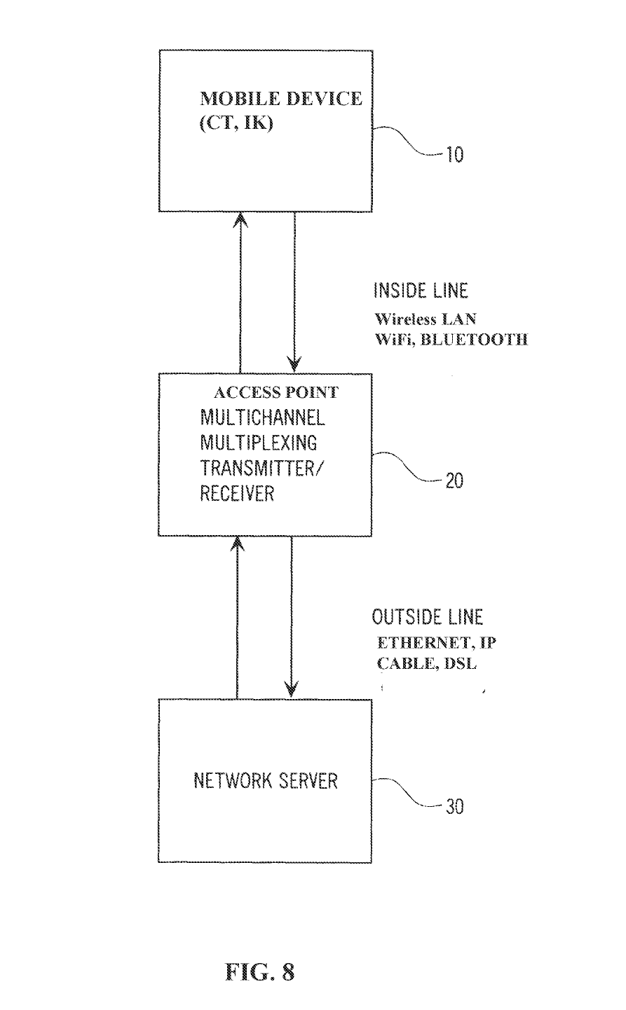

FIG. 8 consists of three distinct blocks, Block 10 being the Mobile Device/Mobile Phone block, Block 20 being the Multichannel Multiplexing Transmitter/Receiver, and Block 30 being the Network Server, all connected by wired or wireless means.

This example describes the use of the Mobile Device/Mobile Phone in the telephony mode. Telephony for voice or data transmission may be initiated by selecting the telephony mode on the Mobile Device/Mobile Phone. This may be activated by voice or key command.

The telephony connection maybe wired or wireless. The connection is completed between the Mobile Device/Mobile Phone and the central multichannel multiplexing transmit/receiver located in the loop. The transmitter/receiver in turn establishes a connection to an outside line for either dialup or Internet access. In this mode, two-way voice or data transmission may be conducted. In addition, specific advance use of language translation capability may be brought online by connecting to a network server on which resides an extensive database capability to translate from one language to another by recognizing the speech patterns of either speaker. Using this database capability the network server is able to provide speech in any selected language at either end. As an example, a speaker conversing in English at one end may have his speech translated to Japanese at the other end. Similarly, the reverse translation can be performed. The server could record the conversations if desired by selecting a record feature.

### Example 9

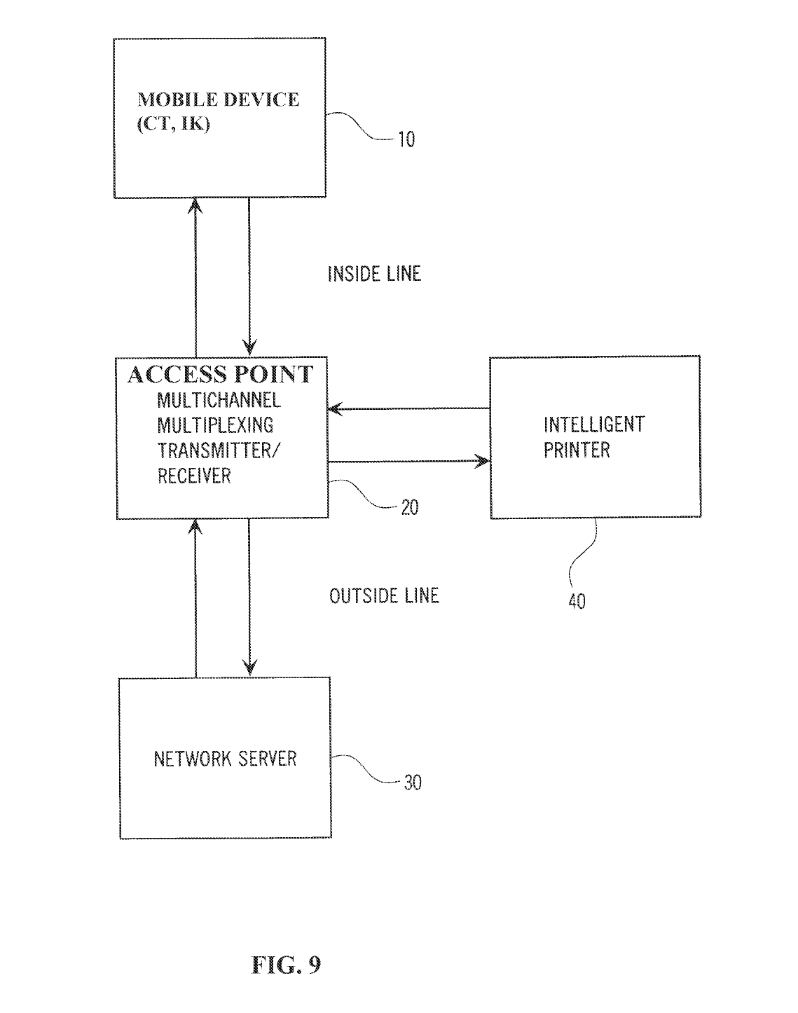

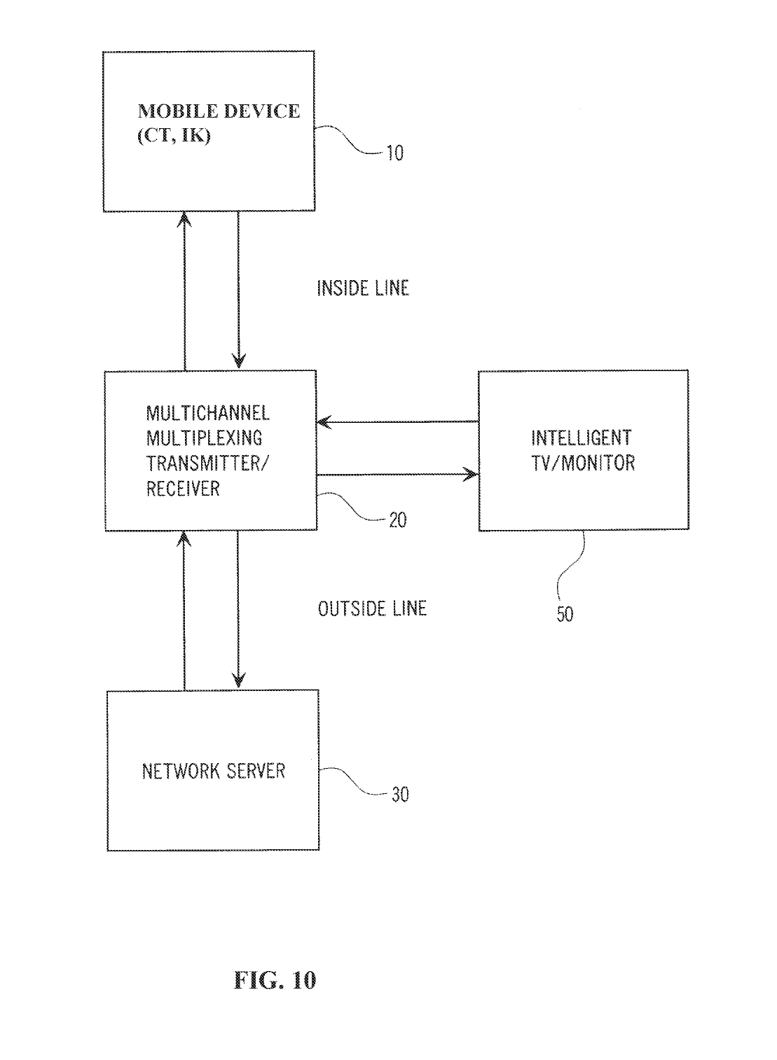

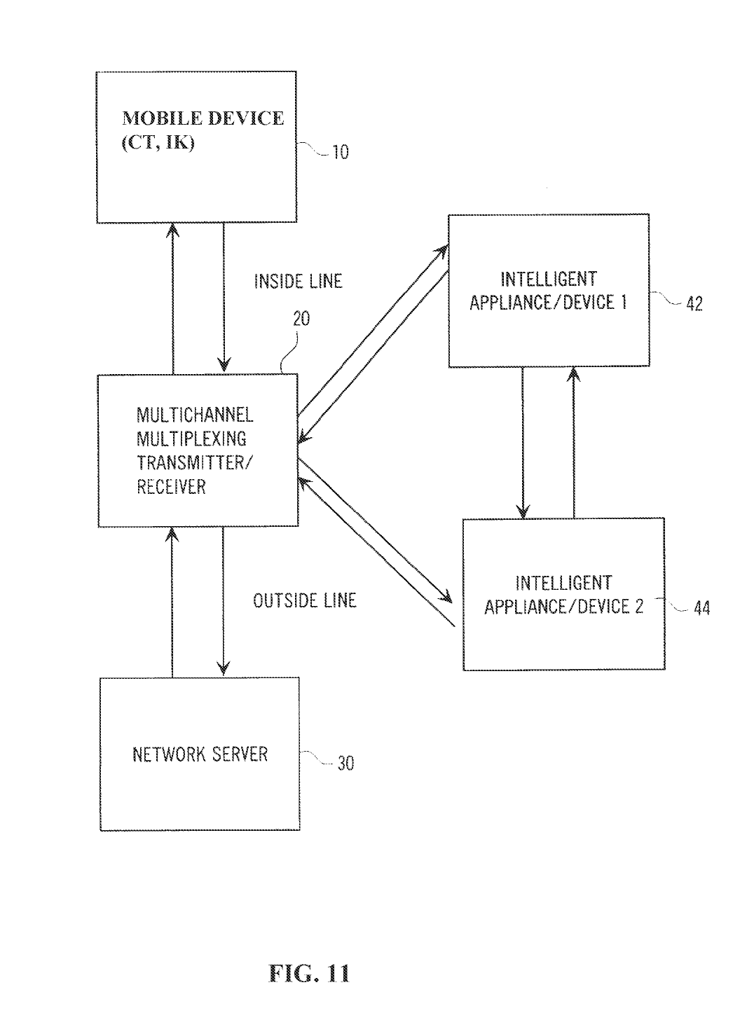

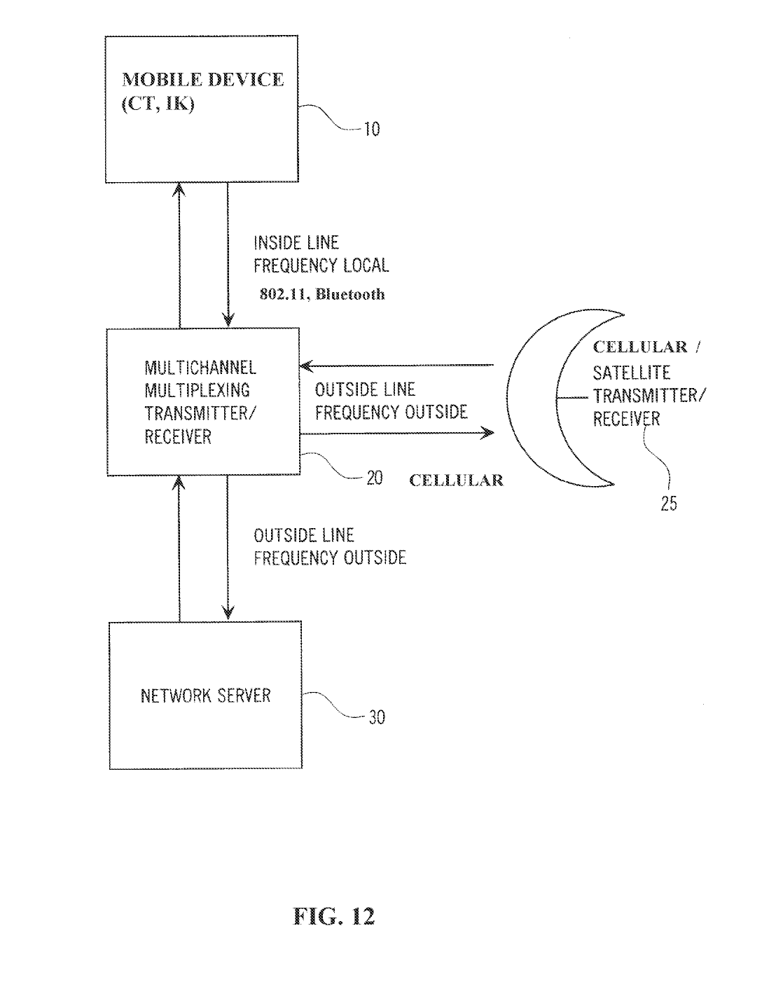

FIG. 9 consists of four distinct blocks, Block 10 being the Mobile Device/Mobile Phone block, Block 20 being the Multichannel Multiplexing Transmitter/Receiver, Block 30 being the Network Server, and Block 40 being an Intelligent Printer, all connected by wired or wireless means.

In this example, a textual transcript of any telephonic conversations could be generated in any selected language using the extensive mapping capabilities for language translation resident on the network server. These features would provide real-time voice translation and transcription capabilities. The text may be printed at either end in a desired language using an Intelligent Printer. Once the Intelligent Printer is part of the loop, it may execute tasks immediately or queue and/or schedule the tasks.

### Example 10

FIG. 10 consists of four distinct blocks, Block 10 being the Mobile Device/Mobile Phone block, Block 20 being the Multichannel Multiplexing Transmitter/Receiver, Block 30 being the Network Server, and Block 50 being an Intelligent TV/Monitor, all connected by wired or wireless means.

The text, graphics, and video may be activated by the Mobile Device/Mobile Phone and viewed on a built-in screen or viewed on an intelligent TV/monitor screen by patching the intelligent TV/monitor screen into the communication loop.

### Example 11

FIG. 11 consists of five distinct blocks, Block 10 being the Mobile Device/Mobile Phone block, Block 20 being the Multichannel Multiplexing Transmitter/Receiver, Block 30 being the Network Server, Block 42 being an Intelligent Appliance/Device, and Block 44 being another Intelligent Appliance/Device, all connected by wired or wireless means.

Multichannel capability and the ability to multiplex the inputs/outputs sequentially or simultaneously for use by a number of intelligent appliances is possible. This multichannel multiplexing capability may exist within each intelligent appliance. The ability to incorporate this feature is driven by need and cost. The advantage is that this feature allows each intelligent appliance and the whole local area network to be used efficiently and effectively by allowing queuing and scheduling of various tasks. The queuing and scheduling tasks is real time and there may be different levels of queuing and scheduling capabilities resident in each intelligent appliance and the local area network.

Certain levels of queuing and scheduling capabilities may exist in the intelligent appliance, another level of capabilities may exist in the central multichannel multiplexing transmitter/receiver and yet another level of capability may exist in the local or network server. The level of capability to queue, schedule, process, receive, and transmit data depends on the number of input and output channels, the size of the data buffer, and whether the inputs and outputs can be multiplexed.

It is also possible to define an embedded transmitter/receiver function with multiple channels with and without multiplexing capability. The basic concept of how these electronic functional blocks can be executed at either the board level or chip level is described. As an example, a quad-in and quad-out transmitter/receiver can have one channel dedicated for telephony, another channel dedicated for TV, another channel for printers, and a channel for security. As an option, specific channels may be multiplexed for use by a number of intelligent appliances. Multiple inputs and multiple outputs (MIMO) may encompass wired and wireless connections including Ethernet, USB, WiFi, and other connections.

In specific, referring to FIG. 11, the multichannel multiplexing transmitter/receiver is described with four channels, one channel being dedicated for two-way communication with the Mobile Device/Mobile Phone, another channel dedicated for two-way communication with the network server, and two other channels each dedicated for two communication with two different intelligent appliances. In this quad configuration, the multichannel multiplexing transmitter/receiver can interact with four different entities having the capability to schedule or process the data real time. Similarly, each of the Intelligent Appliances/Devices may have some built-in capabilities for communication directly with the Mobile Device/Mobile Phone or through the Multichannel Multiplexing Transmitter/Receiver.

### Example 12

Once again referring to FIG. 11, it is possible for a unique identification to be assigned to each Intelligent Appliance/Device to maintain communication protocols. An identification may also include an Internet Protocol version 4 and version 6 address, MAC address, device ID number, a hash of various identifications. Intelligent Appliance/Device 1 would have a specific beginning and ending code that uniquely identifies it. Whenever data is received by the Mobile Device/Mobile Phone or any other device on the network it would be able to identify the source. If Intelligent Appliance/Device 1 has transmitted certain data the Mobile Device/Mobile Phone would identify the source or the multichannel multiplexing transmitter/receiver could queue or transmit the data to the uniquely designated appliance.

The wireless transmission/reception is within the FCC prescribed frequency domain for intelligent appliances and may include public access airwaves and un-regulated private access airwaves. The wireless transmitter/receiver electronics and ICs are designed to conform to the prescribed standards. However, within the local or wide area network significant RF traffic from numerous intelligent appliances may be present with the potential for crosstalk and other problems. To avoid this crosstalk, packets of RF data sent by each intelligent appliances are coded and transmitted in such a way that periodically there will be an identifying string of data that clearly defines the source of the data and the destination. The periodicity of this identifying string data, the length and complexity of this identifying string data, and the encryption of actual data is driven by the level of accuracy and the level of security desired. This ability to encode and decode identifying strings from each appliance allows multiple intelligent appliances to use the same RF frequency domain and co-exist within a local area network. The implementation of this concept requires the hardware described and a pre-defined set of software protocols that may be either industry standard or custom. The protocols may exist at the various layers such as Application, Transport, Internet, or physical areas. Protocols may include DHCP, HTTP, SSL, SMTP, SSH, IMAP, UDP, TCP, IP, L2TP, Ethernet, and others.

### Example 13

Referring to FIG. 12 which shows a block diagram of intelligent devices communicating within the network at a specific frequency of F_{local} and with the outside world via satellite or cellular transmitter receiver, indicated as 12, at a different frequency of F_{outside}.

The central multichannel multiplexing transmitter/receiver (or Access Point) may either connect with the outside world, public networks, Internet resources, through the wire or by wireless, cellular, or satellite means. It is possible that this central multichannel multiplexing transmitter/receiver may communicate in one defined frequency domain within the local or wide area network with all Intelligent Appliances that are part of this network and at same or different frequency domain with the outside world. By extension the reverse concept is also claimed. In this scenario, where there may be a need for two or more different frequencies of communication the transmitter/receiver electronics and chip level solutions can be designed to accommodate for this multiple frequency requirement.

### Example 14

Referring now to FIG. 7, the figure consists of an intelligent electrical outlet with a built-in radio frequency controller. The radio frequency controller has the ability to receive inputs and transmit output such that the electrical outlet can be controlled by the Mobile Device/Mobile Phone or other means. The radio frequency controller consists of the transmit/receive function and the control function including the ability to turn the outlet on and off and perform other variable and programmable control functions. The radio frequency controller consists of a receiver, a processor, controller, programmable logic, and a transmitter. The radio frequency controller electronics may be implemented by those skilled in the art using either standard or custom electronics. The entire controller electronics may be implemented as a monolithic single chip integrated circuit

A block diagram concept of how this embedded RF controller can be implemented at a chip level is shown in FIG. 7. The radio frequency controller can be incorporated on all new electrical outlets and switches to be made in the future, such that they are all intelligent electronic outlets and intelligent electrical switches. Alternatively, a plug-in module may be configured to make existing electrical outlets and electrical switches intelligent. Additionally, this concept of an embedded RF controller may be extended to other sensors that would sense such things as light, temperature, pressure, smoke, to name a few. The radio frequency controller consists of the transmit/receive function and the control function including at a minimum, the ability to turn the switch on and off. It is possible to assign a unique identification to each electrical outlet and each electrical switch to uniquely address and control these units using the Mobile Device/Mobile Phone.

### Example 15

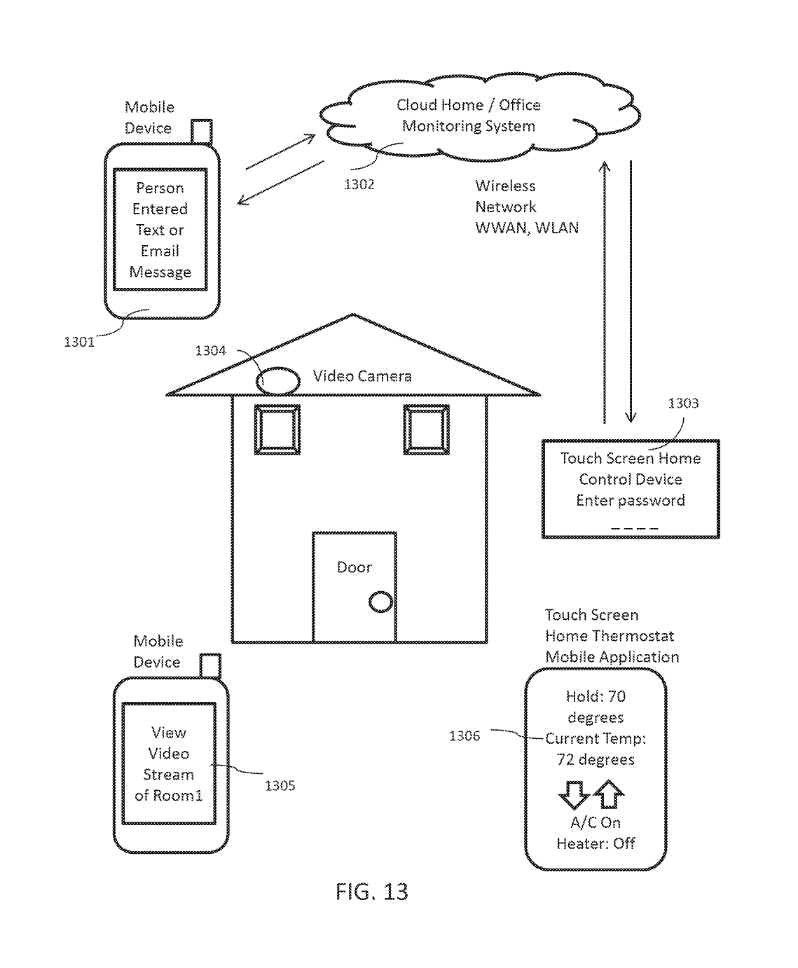

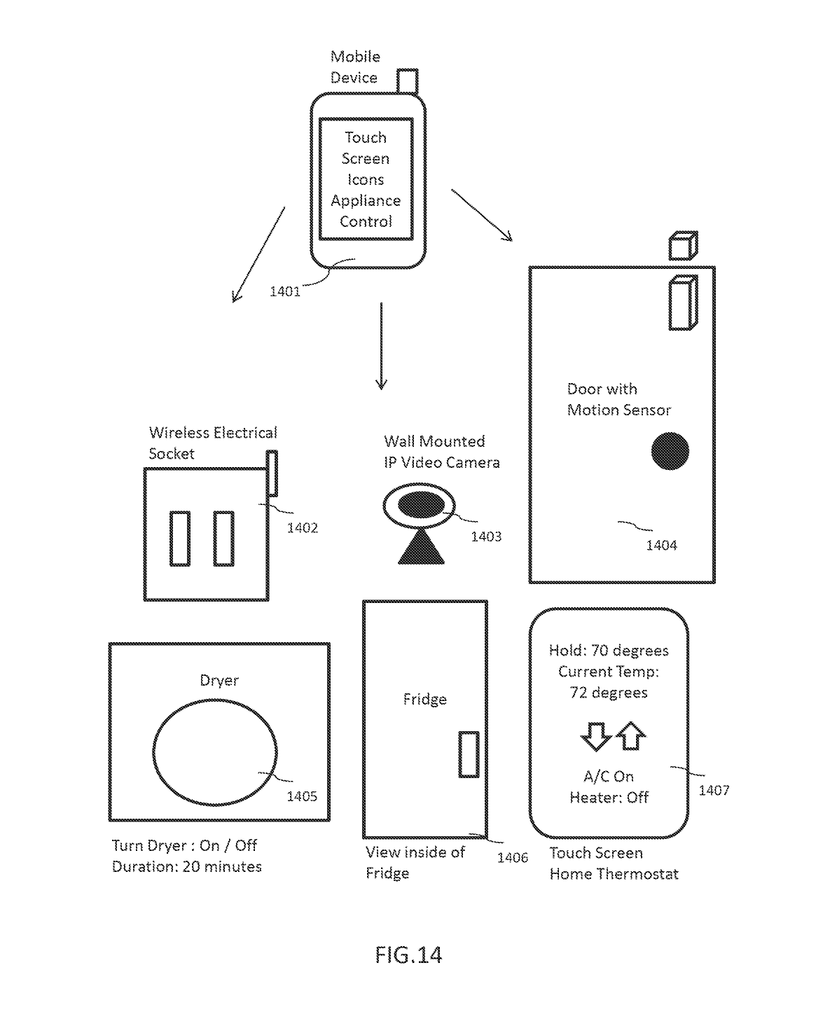

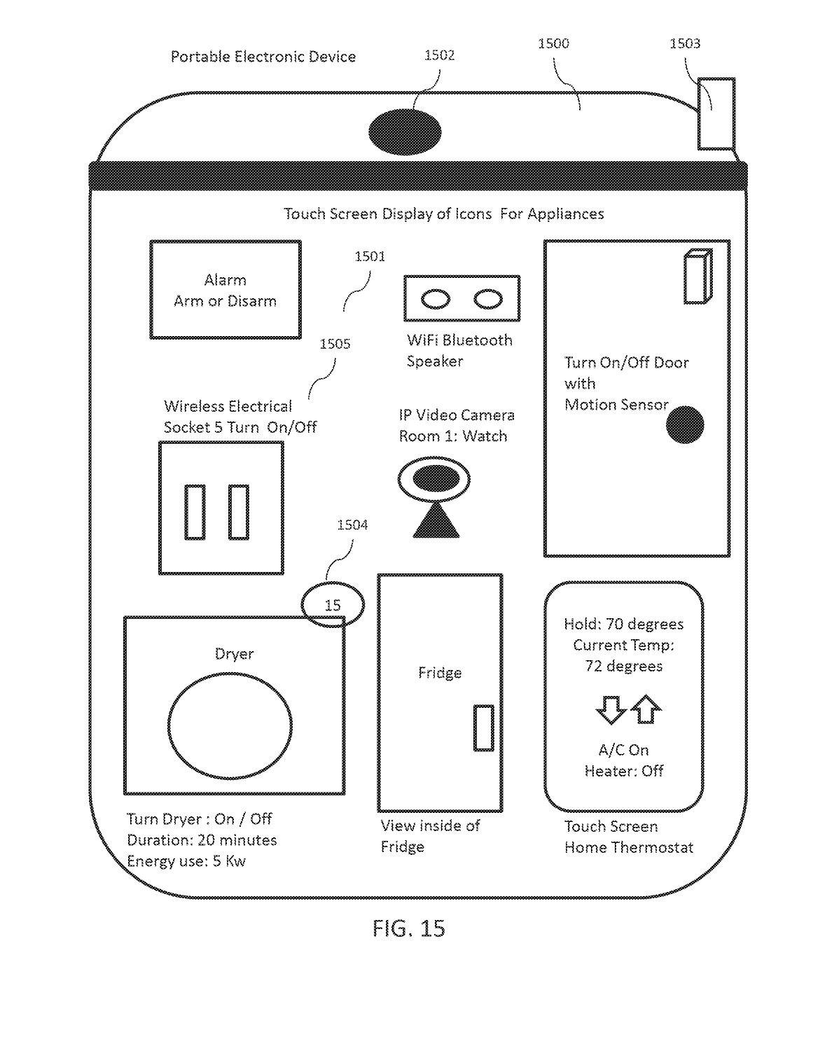

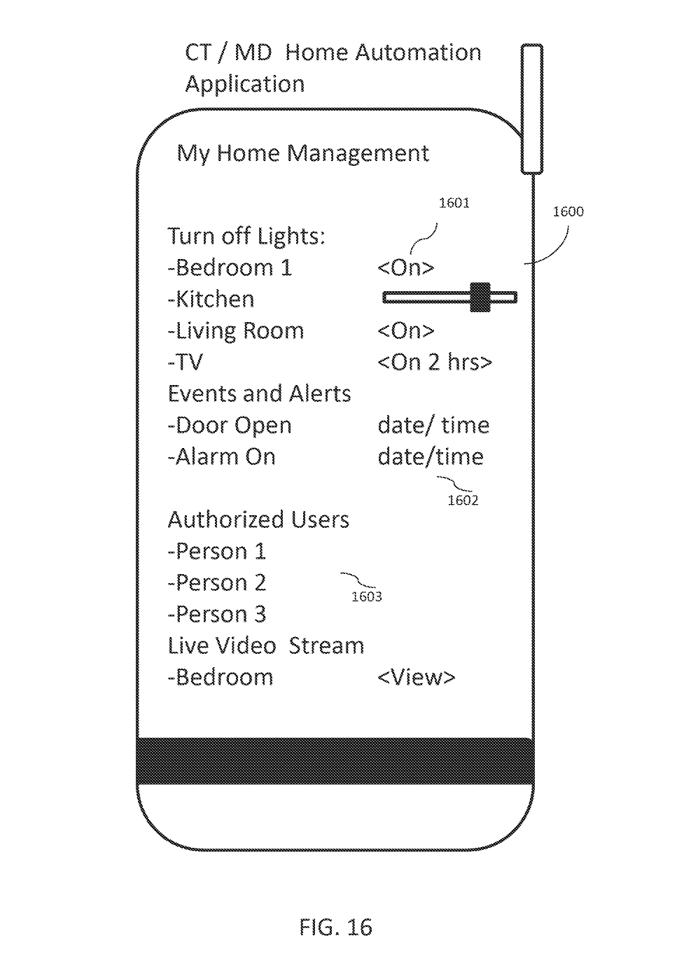

Referring now to FIG. 13, 1301 shows a touch screen enabled mobile device that displays an alert of activity occurring in the house. The display may be an LCD, LED, OLED, AMOLED, or other display type. The Mobile Device/Mobile Phone 1301 receives the message from a cloud based monitoring service 1302. The cloud service 1302 receives this information from devices 1303 located in the house. Device 1303 is an electronic device which allows for control of the monitoring system in the house. A user may enter a password to access the system on the touch screen or be authenticated using one or more methods such as voice recognition, facial detection, retinal scans, and GPS. Various devices including a video camera 1304 may stream video to the cloud monitoring service using Internet Protocol. The cloud service may in turn stream this content to other mobile devices 1301 or 1305. Other devices such as 1306 may be enabled to control energy settings within the house. This may be done on a stationary or portable thermostat or using an application on a mobile device 1301 or 1305. The mobile device 1301 or 1305 may send a control command to the cloud monitoring service which in turn controls local appliances or directly to a local server which controls local devices or directly to the intelligent appliance or directly to a local home management device. In one embodiment, the appliances, electrical switches/outlets or other items may be controlled outside the home using a remote access leveraging a network server. In another embodiment, the appliances may be controlled only when the appliance and the Mobile Device/Mobile Phone are connected to the same wired or wireless network. The various devices including the wireless electrical switch/outlet, video camera, and other items may be modular and portable so that they can be easily positioned and reconfigured within the house or environment.

Referring now to FIG. 14, various devices may be controlled using a Mobile Device/Mobile Phone 1401 including a wireless local area network (WLAN) electrical socket 1402, video camera 1403, door with a motion sensor 1404, dryer 1405, fridge 1406, thermostat 1407, or other appliance. These devices 1401-1407 may be enabled with a cellular, wireless local area network, 802.11x/WiFi, Bluetooth, Zigbee, or other communication radios, transmit/receive components, memory, protocols, and configuration information. The motion sensor 1404 may be mounted above a door and be in connection with a proximate enabled wireless enabled electrical outlet or transmit and receive device. A motion sensor in another variation may use a magnet to detect movement to or away from a sensor component. In another variation a laser or light may be shined between two options and the obstruction or change in the laser or light may be used for movement detection. In another variation, a heat sensor may track movement in the house or a retail store in a different configuration. In another variation a microphone may be used for movement detection as part of a microphone array. The motion sensor may be enabled with a lithium battery, AAA, AA or similar small sized battery. The devices may use a combination of protocols. The motion sensor may use a proximate connection such as Bluetooth or Zigbee to communicate with a local device or longer range connections. The local device may in turn use a communication transmit/receive component with a longer range such as 802.11 or Ethernet to connect to a remote server or cloud infrastructure. The devices may communicate peer to peer, using a local server, using a local Mobile Device/Mobile Phone, or using network accessible servers including a public or private Internet cloud. The devices may further be managed by visiting a specific local IP address such as 192.168.1.X. The firmware on the wireless electrical switches/outlet devices may be modified using a remote server. The channel, bandwidth, security settings including WPA or WEP or MAC Filtering may be enabled or disabled for the devices in conjunction with a Central multichannel multiplexing transmit/receive device (or Access Point). The wireless enabled switches/outlets, video cameras, and related devices may register directly with a local or network server. The registration process may include a unique identifier for each device. A network tunnel may be setup between these home devices and a remote server. This may allow remote access to the home appliances via the remote server or cloud monitoring server from outside the home. The devices and system described may be used outside the home and in an office, store, or other environment.

Referring now to FIG. 15, various icons may be displayed on a Mobile Device/Mobile Phone 1500. These devices may be controlled by touching the display 1501 on the Mobile Device/Mobile Phone 1500. The state of on/off or usage statistics may be viewable. The device may have one or more cameras 1502 and one or more antennas 1503. The Mobile Device/Mobile Phone 1500 may send these control commands and receive device status information using local wireless networks or wide area networks. The icons such as 1504 or 1505 on the display may be pictures, text or other visual items. A server may send messages to the Mobile Device/Mobile Phone 1500 to update the icons on the display including numeric indications of status changes 1504. As an example, a number 1504 above the dryer icon may indicate the number of minutes remaining in a drying cycle. The number displayed on this icon may be displayed as the status of the dryer changes. A server may send the status information to the device. Various configurations, rules, and settings may be defined for each appliance or set of appliances. In one embodiment, a dryer may be defined to turn off after 20 minutes. In another instance, a lamp may be remotely controlled even if the lamp is not an intelligent appliance. The wireless enabled electrical switch/outlet connected to the lamp may be configured to accept remote messages and may power down or turn off/on the outlet. In another embodiment, the light may be enabled to turn on or off at specified intervals. The settings may be configured using a website available on the Internet, mobile application, Software as a Service platform, or a local base station or controller device. A payment system may be enabled for management of the devices and the cloud monitoring service. The configuration settings may be stored directly in memory in each wireless electrical switch/outlet. In another variation, the configuration settings may be integrated directly into the appliance.

Referring now to FIG. 16, a single view of the history and activities in the house may be viewed on the Mobile Device/Mobile Phone 1600 including the current state of various appliances 1601, events 1602, and authorized users 1603 with permissions to control and access various appliances. Events 1602 may be searched, assigned to, or organized by user in the household. Temporary access to the house or an appliance may be enabled by adding a user and setting a duration of access. The location of the individuals may be mapped, geo-fenced, and determined using GPS, Access Point connections and names and locations, network IP address, RFID, NFC, or other location mapping techniques. Each appliance may be mapped to a specific location in the house or office and identified with a description, photo, or internal home map. A slider bar may allow a user to dim lights by making contact with the screen and moving the slider bar from one end to the other.

Thus, while the Mobile Device/Mobile Phone System has been described with reference to specific embodiments and applications, the description is illustrative of the Mobile Device/Mobile Phone System and is not to be construed as limiting the Mobile Device/Mobile Phone System. Various modifications and applications may occur to those skilled in the art without departing from the true spirit and scope of the Mobile Device/Mobile Phone System as defined by the appended claims.

1. The Mobile Device/Mobile Phone may have the ability to communicate with other intelligent devices and appliances through either wired or wireless means. The Mobile Device/Mobile Phone system configuration may combine the standard keyboard functions, display functions, transmit and receive functions, telephony functions, fax and scan functions, voice and speech recognition functions, in addition to serving as a universal command and control unit for appliances and devices that operate using electrical power.

2. The system level configuration for the command and control of multiple intelligent appliances utilizing the Mobile Device/Mobile Phone, an embedded transmit/receive function such as a wireless 802.11 radio that would exist within each intelligent appliance or device, and a Central multichannel multiplexing transmit/receive device (or Access Point) that would be part of a local or wide area network within the home or office. A board level, multichip single package and/or single chip monolithic integrated circuit implementation of the embedded transmit/receive function and the central multichannel multiplexing function is also claimed. The Central multichannel multiplexing transmit/receive device (or Access Point) is capable of multiplexing inputs/outputs from a number of intelligent appliances/devices and communicating via the built-in transmit/receive function across various communication paths and/or lines.

3. The system level configuration where the Mobile Device/Mobile Phone and the Central multichannel multiplexing transmit/receive device (or Access Point) can work in tandem with a local or network server to perform various computing, data processing, and data transmission functions, inclusive of text, graphics, audio, and video.

4. The basic Mobile Device/Mobile Phone has the electronics and computing power to transmit data to and receive data from either a network or local server, which may be a personal computer, or intelligent peripheral or intelligent appliance through either wired or wireless means. The Mobile Device/Mobile Phone may serve as a transmit and receive hub or wireless connection sharing device or mobile hotspot transmitting to and receiving from multiple local devices using a wired or wireless connection and further connecting to remote servers using a cellular or other network.

5. The Mobile Device/Mobile Phone is a device with a speaker and is capable of facilitating interaction between voice recognition software resident on the network server, local server, or on the intelligent appliance and the Mobile Device/Mobile Phone. Mobile Device/Mobile Phone is capable of outputting sound. It is also able to convert sound to data that can be transmitted to a local or network server.

6. Mobile Device/Mobile Phone may have a built-in display and operate with larger external display. This Mobile Device/Mobile Phone is capable of displaying data being sent to or received from the local or network server or other intelligent appliances. This display is capable of showing text, graphics or other data.

7. Mobile Device/Mobile Phone has a transmitter, receiver, a digital signal processor, controller, and display electronics and audio electronics which may be implemented with standard or custom components by those knowledgeable in the art. By using the voice recognition software resident on the local or network server, Mobile Device/Mobile Phone can convert text data into voice and broadcast voice through a speaker mechanism.

8. There can be a transmit/receive functional block built into the Mobile Device/Mobile Phone. The Mobile Device/Mobile Phone can operate through either wired or wireless means.

9. The Mobile Device/Mobile Phone is capable of operating with a built-in operating system and/or an operating system resident on a local or network server or other intelligent devices.

10. The Mobile Device/Mobile Phone is capable of transmitting inputs from either the keypad, display or voice inputs picked up from the microphone to the local server or network server or intelligent peripheral or intelligent appliance for processing, through either wired or wireless means. Voice includes spoken as well as other audio and/or audible tones inclusive of music/sound. Thus one may either send data to software resident on the local server or network server or intelligent peripheral or intelligent appliance through the keypad on the Mobile Device/Mobile Phone, through voice commands, through the display by touching the screen, through a pen which interacts with the display, or through another device which interfaces with the Mobile Device/Mobile Phone.

11. Mobile Device/Mobile Phone is capable of taking input and output through a transmit/receive functional block, a telephone line, cellular line, WiFi line, an Ethernet line or other form of data communication. These inputs and outputs are then processed by a local or network server and are relayed back to Mobile Device/Mobile Phone and/or the display.

12. Mobile Device/Mobile Phone can be hooked to a local area network or wide area network, including, the Internet, through either wired or wireless means, to receive inputs of text and/or voice and to send outputs of text or voice depending on the user's choice. Voice sent to a local or network server could be stored as a data file. Voice may be in any language since the Mobile Device/Mobile Phone leverages the language capabilities of the local or network server.

13. Mobile Device/Mobile Phone may also work in tandem with a local or network server to receive text or voice data and process these inputs for audio output. The primary computing power/protocols and software reside on the server.

14. The Mobile Device/Mobile Phone is capable of interacting and commanding many intelligent peripheral devices around the home or office through either wired or wireless means and thus is a universal keyboard. The Mobile Device/Mobile Phone or Access Point can assign/reassign an identification number to each peripheral or appliance. With this unique identification number and the processing capability of the local or network server, the Mobile Device/Mobile Phone can then control that particular intelligent appliance or other peripheral devices. The intelligent appliances will have programmation capability to set or change identification and encryption. This programmation capability can be easily accessed and controlled by the Mobile Device/Mobile Phone. This will allow the Mobile Device/Mobile Phone to re-configure various intelligent appliances as needed by the user. All the appliances and peripherals will subscribe to the same protocols such that they will be able to communicate to each other and execute instructions. A user may also use the programmation capability of the Mobile Device/Mobile Phone to assign a password or other security measures, such as data encryption to a particular intelligent appliance. Thus, unauthorized control of intelligent devices will be prevented.

15. The Mobile Device/Mobile Phone can use its transmit/receive device to transmit data to and receive data from a cloud or local or network server or intelligent peripheral or appliance through either wired or wireless means. In this scenario, the local or network server will perform any computation that is necessary. The transmit/receive can be either single or multichannel. This means that the transmit/receive device which is built into the Mobile Device/Mobile Phone can receive all of its input from the Mobile Device/Mobile Phone or it can receive many different inputs from various intelligent appliances and peripherals simultaneously or sequentially.

16. Other features and options may be added to the Mobile Device/Mobile Phone. For example, the Mobile Device/Mobile Phone can possess more processing power such that it can perform basic computations and will not have to directly communicate with the local or network server to perform certain functions. For example, Mobile Device/Mobile Phone may possess more processing power so that it can assign an identification number to various appliances and peripherals, recognize various appliances and peripherals and so that it can assign instructions for these appliances and peripherals to execute. Other features such as data storage can be added to the Mobile Device/Mobile Phone. A module or storage device can be built in to the Mobile Device/Mobile Phone to record and store data and voice. For example, this can be accomplished by using a storage card, SD, miro-SD or other memory card. Mobile Device/Mobile Phone can be connected to a mouse, electronic pen, CD-ROM, printer, CRT/TV by either wired or wireless means. As an option a scanner may interface with the Mobile Device/Mobile Phone so that documents can then be sent to the local or network server for further processing. Another option is to enable a printer to interface with the Mobile Device/Mobile Phone to print data locally.

17. The transmit/receive controller electronics block diagram, as shown in FIG. 6, can be implemented by those skilled in the art with either standard or custom electronics. The entire controller electronics may be a single chip integrated circuit. It is anticipated that all intelligent appliances would utilize this block diagram as a universal and requisite embedded feature. As described in FIG. 6, this embedded transmit/receive function may come in multiple configurations of inputs and outputs. In dual channel configuration, the multiplexing transmit/receive device has two inputs and two outputs. This will allow an intelligent appliance to sequentially or simultaneously be addressed by the Mobile Device/Mobile Phone for either sequential or simultaneous output. In addition, it is possible for the multichannel multiplexing transmit/receive function to be incorporated on a mother board or a daughter board of a personal computer, server, or other computing/processing device.

18. The Mobile Device/Mobile Phone, the multiplexing transmit/receive device, and the system configuration and protocols described in this Mobile Device/Mobile Phone system allow the Mobile Device/Mobile Phone to fully serve as a universal command and control module. As an example, the Mobile Device/Mobile Phone can serve as a wireless telephone, cellular telephone, video phone, or IP phone. As another example, the Mobile Device/Mobile Phone can turn lights on and off in a particular location of a house, interface with a home security system, or control a home security system including appliances, thermostats, entry exit points such as doors or windows, lights, outlets, locks, emergency contact centers, motion sensors, fixed or rotatable wireless local area network enabled video cameras or still cameras, microphones, speakers and other sound systems. As another example, events may be sent using text message, email, or another communication method. Various configurations based on time of day or behavior patterns may be used to control and configure usage of applications from inside the house or using one or more Mobile Device/Mobile Phones. As another example, the Mobile Device/Mobile Phone can accept voice input and through the Mobile Device/Mobile Phone's use of the processing power of the local server or network server or other intelligent device, the Mobile Device/Mobile Phone can convert this voice into text for printing by an intelligent printer. As another example, the Mobile Device/Mobile Phone may interact with a diversity of electronic equipment, such as garage doors, security systems, printers, televisions, washing machines, ovens, stove tops, personal computers, and other electronic devices. The Mobile Device/Mobile Phone can have its own antenna.

19. The Mobile Device/Mobile Phone may have a keyboard configuration that provides either a partial or a full function keyboard which can be folded or collapsed to achieve a compact size and portability. The display, which may be both built-in or external to the Mobile Device/Mobile Phone, may also be folded or collapsed to achieve a compact size and portability. The Mobile Device/Mobile Phone, may use local or network processing.

20. The Mobile Device/Mobile Phone can command and control each and every electrical outlet or switch through either wired or wireless means. The smart wireless enabled electrical outlet or switch may be configured for a two or three prong device and for various voltages such as those between 110 Volts to 220 volts. The switch may be dynamically configurable for international use across various voltage ranges. Refer to FIG. 7. Each electrical outlet and/or switch may be configured to have a radio frequency transmit/receive controller and associated electronics built into it which would enable the Mobile Device/Mobile Phone to communicate and control each outlet and switch. The electrical outlet may have its own antenna or it may use the wiring of the house as its antenna for communication with the Mobile Device/Mobile Phone and/or other devices. This can be accomplished by having a unique identification number for each outlet and switch which can be programmed by the user. The Mobile Device/Mobile Phone not only addresses, commands, and controls intelligent appliances and devices, it can also interface with each electrical outlet, electrical switch, and sensors thereby controlling appliances and devices that may traditionally not have had these intelligent functions built-in.

1. A system comprising:
a wireless enabled electrical switch comprising: a housing, wherein the housing provides a plug point for a electrical appliance; a connection in the housing to A/C electrical power outlet; a wireless transmit and receive unit; wherein the electrical switch is identified by a unique identifier;
and wherein the electrical switch is configured for control by a software application stored in a non-transitory computer readable medium configured to run on a portable electronic device, wherein the mobile device comprises a touch sensitive display, a processor, a memory, and a wireless transmit and receive unit for wireless local area network (WLAN) communication.

2. The system of claim 1, wherein the application is configured to control one or more electrical switches; wherein the application provides an option to turn an electrical switch on or off; and wherein the electrical switch is further configured to accept a control message from the application running on the portable electronic device.

3. The system of claim 1, wherein the application sends to the electrical switch a command to turn the power on the electrical switch outlet on or off.

4. The system of claim 1, wherein the electrical switch is configured for remote access using Internet Protocol.

5. The system of claim 1, wherein the electrical switch and mobile device are configured to communicate using a local home wireless LAN.

6. The system of claim 1, wherein the switch is accessible using a wireless LAN network utilizing a private home airwave.

7. The system of claim 1, wherein the switch is accessible using a public cellular airwave.

8. The system of claim 1, wherein the mobile device sends a request to change the state of the electrical outlet using a local wireless network.

9. The system of claim 1 wherein the electrical switch is programmable with configuration settings.

10. The system of claim 1, wherein the electrical switch is programmable with configuration settings including a default or built-in set of options stored in a memory housed in the electrical switch.

11. The system of claim 1, further comprising a server, wherein the server tracks the state of each electrical switch by identification number, wherein the server is configured to accept multiple connections from a plurality of portable electronic devices, and wherein the server sends to the portable electronic devices the current on/off state of the switch.

12. The system of claim 1, further comprising an electrical switch configured with at least one sensor, wherein the sensor is enabled to sense one or more of the following including light, temperature, pressure, or smoke.

13. The system of claim 1, wherein the electrical switch is modular, wherein the electrical switch contains two or three prongs, wherein the electrical switch may plug in to an electrical outlet, and wherein the electrical switch may be removed from a fixed position wall electrical outlet.

14. The system of claim 1, wherein the electrical switch is integrated into a fixed position wall outlet.

15. The system of claim 1, further comprising a multichannel multiplexing transmit and receive device (MMTR) or access point (AP), wherein the electrical switch is configured to communicate to the mobile device using a MMTR or Access Point.

16. A system comprising:
a wireless enabled electrical switch comprising: a housing configured with a plug point for an electrical device; a processor; a programmable logic component; an antenna integrated into the housing; a radio integrated into the electrical switch, wherein the radio is communicatively coupled to the processor, and wherein the radio is configured send a signal stream using the integrated antenna; and wherein the electrical switch is a modular handheld switch that may be plugged into a separate fixed positioned wall outlet.

17. The system of claim 16, wherein the electrical switch further comprises at least two prongs, and wherein the electrical switch may be connected to the wall outlet by the prongs plugged into a fixed position wall outlet.

18. The system of claim 16, wherein a antenna is configured to send the signal stream to a multichannel multiplexing transmit and receive (MMTR) or access point device.

19. The system of claim 16, further comprising a mobile phone, wherein the mobile phone communicates data using a local server.

20. The system of claim 16, further comprising a mobile phone, wherein the mobile phone communicates data to the electrical switch using Internet Protocol over a local wireless network.

21. The system of claim 20, wherein the mobile phone receives the identification information for an electrical switch, wherein the mobile phone sends to the electrical switch a control message, wherein the control message comprises an on or off command, and wherein the electrical switch changes the on or off state of the power based on the received command message from the mobile phone.

22. The system of claim 21, wherein a user may swipe a slider on the display of the mobile phone to make brighter or dim a light connected to the electrical switch.

23. The system of claim 21, wherein the mobile phone functions as a multifunction communication device.

24. The system of claim 16, wherein the mobile phone controls a household appliance.

25. The system of claim 21, wherein each electrical switch is uniquely identified by an IP address.

26. The system of claim 21, further comprising a cloud monitoring service, wherein the state of the electrical outlet is sent to a network server.

27. The system of claim 21, further comprising a first and second wireless enabled electrical switch communicatively coupled to a server.

28. The system of claim 21, further comprising a IP enabled video camera, wherein the IP enabled video camera streams acquired video to a network accessible server, and the network accessible server streams the video to the mobile phone.
